(19) United States
(12) Patent Application Publication
(10) Pub. No.: US 2013/0262155 A1
(43) Pub. Date: Oct. 3, 2013

(54) SYSTEM AND METHOD FOR COLLECTION AND DISTIBUTION OF MEDICAL INFORMATION

(71) Applicant: Thomas J. Hinkamp, Winnetka, IL (US)

(72) Inventor: Thomas J. Hinkamp, Winnetka, IL (US)

(21) Appl. No.: 13/856,382

(22) Filed: Apr. 3, 2013

Related U.S. Application Data
(60) Provisional application No. 61/619,874, filed on Apr. 3, 2012.

(51) Int. Cl. G06Q 40/08; G06F 19/00

(52) U.S. Cl. CPC G06Q 40/08; G06F 19/328
USPC 705/4

(57) ABSTRACT

A system for decentralized collection and distribution of medical information through mobile devices. End users interact with the system through a software application installed on a mobile device. Data entered to the application is synced to a server that backs up the data and serves to populate a database of personal health data for analysis. Results of such analyses create value through medical management and informational intervention strategies tailored to meet evidence-based needs and preferences. Based on the analyses, end users and clinicians have the ability to visualize dynamics in health metrics relative to thresholds and to assess the efficacy of therapies and trends in vital signs/labs/vital functions. Functionalities of the system include the ability to populate medical records of end users, inform the full range of medical decision-making opportunities without the need for further examination, maintain adherence to existing evidence-based guidelines, and support the development of new clinical knowledge.

### CROSS REFERENCE TO RELATED APPLICATIONS

This application claims benefit of U.S. provisional patent application Ser. No. 61/619,874, filed on Apr. 3, 2012, which is hereby incorporated by reference in its entirety.

### BACKGROUND

Rapid increases in the cost of healthcare have turned the healthcare sector into a focus area for politicians, scientists, engineers, entrepreneurs, and care givers. At the same time, the healthcare system's ability to prevent, diagnose, treat, and manage chronic and acute diseases has never been greater and continues to grow. These forces, combined with significant advances in the capacity to securely capture, store, and analyze health data from decentralized sources promise to support medical decision making to improve the quality and cost effectiveness of healthcare. The amount and complexity of information generated has exceeded the ability of humans to synthesize and act upon, leading the need for health information technology (HIT) solutions. Successful implementations of information technology by healthcare service organizations including the use of electronic medical records, e-prescribing systems, tele-medicine, and clinical decision-support systems.

As evidence-based guidelines become more complete, there is increased recognition that best-practice care is not a one-size-fits-all standard. In order to take advantage of the depth and breadth of clinical knowledge available, systems must be in place to not only capture the comprehensive health data necessary to inform decision-making, but also to engage patients in shared-decision making and informal processes of care. As healthcare systems become more decentralized, there is an increasing need to record and track outpatient data. Furthermore, the ability of the healthcare system to prevent death has contributed to an aging population, with increased prevalence of chronic disease, which requires monitoring and management.

The development of mobile devices (including, for example, MP3 players, smart phones, and tablets) in conjunction with the prevalence of wireless internet connectivity through Bluetooth telecommunications and Wi-Fi networks with high data speeds make distributed collection and synchronization of individualized health data a reality. As of 2011, there were over 200 million data-capable wireless devices in the U.S. alone. According to certain forecasts, the worldwide number of online mobile devices is expected to reach 1 billion by 2013. Valdez, et al. (VALDEZ, et al., “Industrial and systems engineering and health care: Critical areas of research”—final report. AHRQ Report, 2010) report that in the area of systems monitoring for knowledge innovation for healthcare systems, the creation of “consumer-facing health IT solutions that allow patients to self-report their observations, that track and report on trends, and that interact with providers' annotations” would be a breakthrough for healthcare systems engineering. Although software applications to run on such devices have been designed for healthcare purposes, they fall short of the functionalities offered by the present disclosure.

### SUMMARY

Embodiments of the disclosure provide for decentralized collection and distribution of medical information through mobile devices. Embodiments facilitate the entry, storage, tracking, visualization, and analysis of comprehensive personal health information. End users interact with a healthcare system through a software application installed on a mobile device. Data entered to the software application manually or from peripheral health measurement devices is automatically synced to a server. This server not only backs up the data held on the mobile devices, but also serves to populate a database of comprehensive personal health data for scientific analysis and review. Results of such analyses create value through medical management and informational intervention strategies tailored to meet the evidence-based needs and preferences of the end user. Based on the data captured and the analyses performed, both end users and clinicians have the ability to visualize dynamics in health metrics relative to thresholds and to assess the efficacy of therapies and trends in vital signs/labs/vital functions. Some functionalities of the system include the ability to populate medical records of end users, to inform the full range of medical decision-making opportunities without the need for further examination, to maintain adherence to existing evidence-based guidelines, and support the development of new clinical knowledge.

One embodiment provides a method for providing insurance. The method includes receiving health information from one or more users; analyzing the health information to determine whether the one or more end users are complying with healthcare recommendations, and adjusting insurance premiums based on whether the one or more end users are complying with the healthcare recommendations.

Another embodiment includes a system for collecting and analyzing health information of end users. The system includes a server that communicates with a mobile device associated with an end user, where the mobile device is executing a healthcare software application for collecting health information from the end user, and where the server communicates with computational and analytical resources that analyze the health information collected from the end user.

### BRIEF DESCRIPTION OF THE DRAWINGS

FIG. 1 is a conceptual diagram illustrating a system including end-user interaction through a mobile device application, data collection from peripheral health measurements devices, and a two-way communication between the server and a number of different additional resources, according to one embodiment.

FIG. 2 is a conceptual diagram of a mobile device executing an application and a first page of the application, according to one embodiment.

FIG. 3 is a conceptual diagram of data entry alternatives for specialized data elements, according to one embodiment.

FIG. 4 is a conceptual diagram illustrating a graphical representation of data elements, according to one embodiment.

FIG. 5 is a conceptual diagram illustrating back end functions of a healthcare system, according to one embodiment.

FIG. 6 is a conceptual diagram illustrating how data is entered into a healthcare application, according to one embodiment.

FIG. 7 is a conceptual diagram illustrating how a healthcare application would query users, receive responses, and record those responses on a server, according to one embodiment.

FIG. 8 is a conceptual diagram illustrating how a healthcare application interacts with prescriptions and/or a pharmacy, according to one embodiment.

FIG. 9 is a conceptual diagram illustrating a summary of a user's profile, according to one embodiment.

FIG. 10 is a conceptual diagram illustrating a medication/pharmacy module associated with a healthcare application, according to one embodiment.

FIG. 11 is a conceptual diagram illustrating an example of a first page of a healthcare application designed for elderly patients, according to one embodiment.

FIG. 12 is a conceptual diagram illustrating a user workflow of a healthcare application, according to one embodiment.

FIG. 13 is a flow diagram of method steps for providing health insurance, according to one embodiment.

FIG. 14 is a conceptual diagram illustrating an expanded medication section of a healthcare application, according to one embodiment.

FIG. 15 is a representation that may be created using 3D modeling and 4D time sequencing to understand changes in medical history, according to one embodiment.

FIG. 16 is a representation of data that may be incorporated in anatomic modeling, according to one embodiment.

FIG. 17 is a conceptual diagram illustrating a virtual healthcare room, according to one embodiment.

### DETAILED DESCRIPTION

Embodiments of the disclosure provide for decentralized collection and distribution of medical information through mobile devices. Embodiments facilitate the entry, storage, tracking, visualization, and analysis of comprehensive personal health information. Some embodiments provide a “virtual patient.” A software system is configured to collect information with a time stamp and allows the data to represent the individual person (or organism) in terms of current and ongoing physiology. Data collected may include, for example, blood, urine, and fluids evaluation. Data may also include organ function, surgical reconstructions, implants, organ removal, and/or transplantation. Data may also include medications and times taken or given. The data may further include one or more of medications and infusion rates, ventilator settings, amount of oxygen in use, DNR (do not resuscitate) status, protocols in use, tubes, lines, and catheter in use. The medication data might be oral or IV (intravenous), or administered by another route. In some embodiments, anything medical done to the person is listed and incorporated into the data set. This data set can create a virtual 2D (two-dimensional), 3D (three-dimensional), or 4D (four-dimensional) virtual anatomic patient (or animal or organism).

In some embodiments, end users interact with a healthcare system through a software application installed on a mobile device. Data can be entered to the software application manually, by voice, Bluetooth, or digitally from CT (computed tomography), MRI (magnetic resonance imaging), or XRAY testing, or from peripheral health measurement devices (e.g., sensors, embedded or not). The data can be automatically synced to a server. This server not only backs up the data held on the mobile devices, but also serves to populate a database of comprehensive personal health data for scientific analysis and review. 2D, 3D, and 4D visualization create additional health information to construct and evaluate health intervention processes. Results of such analyses create value through medical management and informational intervention strategies tailored to meet the evidence-based needs and preferences of the end user. Based on the data captured and the analyses performed, both end users and clinicians have the ability to visualize dynamics in health metrics relative to thresholds and to assess the efficacy of therapies and trends in vital signs/labs/vital functions. Some functionalities of the system include the ability to populate medical records of end users, to inform the full range of medical decision-making opportunities without the need for further examination, to maintain adherence to existing evidence-based guidelines, and support the development of new clinical knowledge.

One embodiment provides a method for providing health insurance. The insurance may also be auto, home, disability, life, and/or long term care insurance, among others, where creation of a virtual patient and visualizing goals, trend, and targets creates a better understanding of risk and provides the user the opportunity to create value from personal decisions. Risk profiles are part of new knowledge generated from health data aggregated in this way. Achieving goals or making it into a “red zone,” or trending in the correct direction creates health value. Embodiments include receiving health information from one or more users; analyzing the health information to determine whether the one or more end users are complying with healthcare recommendations, and adjusting healthcare premiums based on whether the one or more end users are complying with the healthcare recommendations. Value created using this system may translate into cost savings for insurance company, hospital, physician, Medicare, or other healthcare entity. This value may be a monetary value.

Another embodiment includes a system for collecting and analyzing health information of end users. The system includes a server that communicates with a mobile device associated with an end user, where the mobile device is executing a healthcare software application for collecting health information from the end user, and where the server communicates with computational and analytical resources that analyze the health information collected from the end user. Analytic tools in the recommendation engine immediately see trends and act to make medication recommendations or ask for additional testing to help make better decisions. For example, a patient's blood pressure may be trending out of bounds. The system could analyze age, weight, height, kidney function, gender, and genotype as well as heart risks, and recommend new medication or a change in dose of old medication. In another example, a patient turns 50 years old and a recommendation is made for a colonoscopy and how long to be off “blood thinner” before the test.

In another embodiment, a time and a health calendar are provided allowing visualization of day, week, and/or month. GPS (global positioning system) also functions to create location understanding of health. In some embodiments, the calendar can be viewed by one or more healthcare providers and/or the patient. In some embodiments, messaging incorporated into the system allows health query of the person and sending updated calendar (e.g., for appointments), testing, and reminders of goals. Knowledge modules may also be sent in the form of messages (e.g., text and/or video) to enhance and inform on healthcare goals and reasoning. For example, the messages from the server to patient may be provided after analysis of real time health trends. Also, in some embodiments, surveys are sent to evaluate understanding.

According to various embodiments, a system provides a summary sheet creating quick, immediate registration opportunity for a patient at new healthcare office. The summary may include a problem list, medications, surgeries, implants, allergies, blood type, and most recent blood, and other testing, among others. The summary may incorporates images, for example, a patient's ID and insurance cards, as well.

Embodiments of the disclosure relate to a healthcare system and healthcare application intended for collection, storage, synchronization, analysis, and review of comprehensive health data from end users. The healthcare system and the healthcare application are also herein to herein by name the name “iVitals.”

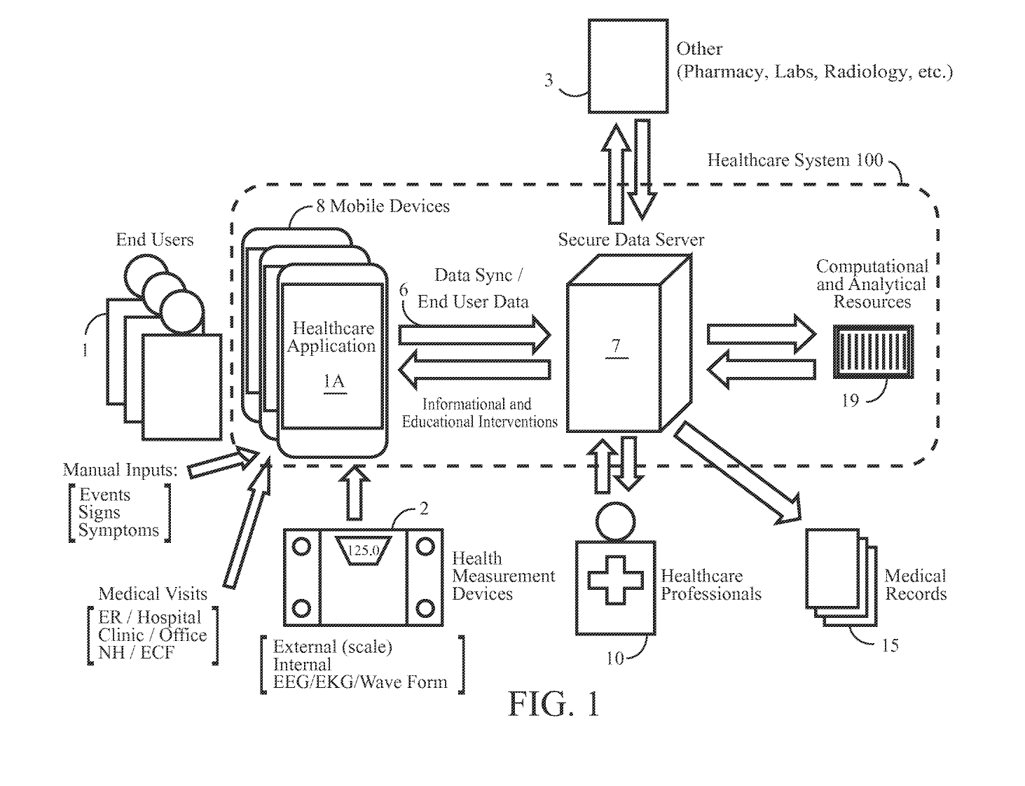

FIG. 1 is a conceptual diagram illustrating a healthcare system 100 including end-user interaction through a mobile device application 1A, data collection from peripheral health measurements devices 2, and a two-way communication between server 7 and a number of different additional resources 19, according to one embodiment.

At the highest level, as shown in FIG. 1, the healthcare system 100 includes a software application 1A, a server 7, and resources 19. The software application 1A is executed on mobile devices 8 that are being used by end users 1. The secure data server 7 backs up data and functions as a data hub. The healthcare system 100 is intended to track comprehensive health information including a person's biological systems, for example, DNA, RNA, medications, blood work, health behaviors, answers to questions, and current and historical healthcare received.

The end users 1 of the healthcare system 100 can be generally thought of as healthcare consumers or simply as operators of mobile devices. In particular, the end users 1 of the healthcare system 100 are not necessarily current patients or individuals with specific ongoing monitoring needs (e.g. diabetics). The healthcare system 100 is designed for all current and potential healthcare consumers including individuals looking to improve health or prevent disease, managing chronic health conditions or disease states, and individuals preparing for an encounter or recently discharged from the healthcare system. The end users 1 interact with the healthcare system 100 through an application 1A installed on a wireless, internet ready, and data-enabled mobile device 8 such as a smart phone, tablet computer, or other mobile computing platform. The application 1A is also referred to herein as the healthcare application 1A.

End users 1 of the healthcare application 1A may enter data manually, through health measurement sensors embedded within the mobile device 8 itself, or by connecting to peripheral health measurement devices 2 such as scales, blood sugar monitors, blood pressure meters, pacemakers, intravascular volume recorders, or wireless AAA (abdominal aortic aneurysm) sac measurement devices, among others. Examples of data that can be entered manually or received from health measurement devices 2 include vital signs, blood work, genotype, vaccination information, infection information, implant information , biological indices (e.g., Glasgow, CIWA (Clinical Institute Withdrawal Assessment), pain), images (e.g., CXR (chest x-ray), EKG (electrocardiogram), CT (computed tomography)), waves of physiological data, and video, among others. Data entry may include various codes of conditions or treatments.

Data may include that which is not directly or precisely measurable. Examples of such data includes: adverse events (e.g., blacked out, sprained ankle, temporary loss of vision) signs (e.g., hives, flank ecchymosis), and symptoms (e.g. diarrhea, fever, a description of a rash). The nature of mobile devices 8 allow them to be within arms reach of end users 1 for the vast majority of each day, allowing the healthcare system 100 to create a comprehensive and robust record of outpatient health. Included in this health record are observations that occur at home, work, during an encounter with the healthcare system 100, during sleep, on vacation, etc., much of which is not currently being captured by conventional systems. Data may be entered with touch, text, voice, Bluetooth® and RF (radio frequency), etc. Data entry is recorded with a time stamp, GPS (global positioning system) coordinates, and/or registration information (i.e., registrant, if other than user). Some of the data entry may be requested by the healthcare application as a query to the end users 1. A message or voice may request input from the end user 1. Examples include: “How are you today?” or “How are you feeling?” Answers to queries are examined and the data is recorded and added to data bank as well as flagged for possible healthcare interactions.

Data that is captured through the healthcare application 1A is automatically synchronized 6 with the secure data server 7 of the healthcare system 100, also herein referred to as the “iVitals server 7.” The server 7 functions as a central repository for back up storage for the distributed end users 1 and associated mobile devices 8. The server 7 also serves as a data host for the computational resources 19 of the healthcare system 100, healthcare professionals 10, and external scientific and academic researchers (not shown in FIG. 1). The server 7 can populate the electronic medical records 15 of providers that end users interact with for health care. The medical records 15 are populated with the usual permissions, encryption, and HIPPA (Health Insurance Portability and Accountability Act, 1996) restrictions. Data population of a remote medical record (MR) 15 uses registration, authentication, permissions and/or encryption. Registration of data may include biometric identification, i.e., data may be tagged with biometric identifier and time/place stamps to ensure authentication and permissions to populate a user's database. Supplementing inpatient data with the outpatient data collected by the healthcare system 100 contributes significantly towards building the complete health history and profile of an end user 1. The data used to populate these additional MR datasets would be noted as different outpatient data and may be assigned a different reliability index. A separate color, for example, may be used to differentiate the healthcare application data from data taken in a medical office or hospital setting.

HL7 (Health Level Seven International) or other health languages may be used to convert this data to a medical record 15. This allows the server 7 to take outpatient end user information and populate the medical record 15 of physician to create a more robust health care profile that will improve the ability of the health care professional utilizing that medical record 15 to tailor a recommendation and treatment plan for the individual patient. In this way, remote healthcare interactions (for example, vaccinations) get recorded in the medical record 15 after first being incorporated into data set in the mobile device software, iVitals.

Some data may be entered by end user 1 via a web portal on a computer with appropriate permissions and authentication for both the end user 1 and/or a health professional. A health professional would need permission from the user as per HIPPA requirements. In one embodiment, all interactions with the data server are recorded. Any data from the healthcare application 1A could also be e-mailed to the server 7.

The computational resources 19 of the healthcare system 100 are used for analysis of the data collected through the mobile devices 8 of end users 1. The set of analyses and algorithms performed by the computational resources 19 is not limited by the scope of the discussion discussed herein. For example, the set of analyses may include conformance with state-of-the-art evidence-based guidelines, anomaly and trend detection, and data mining for new evidence-based knowledge, among others. The data is placed in a set where complex analysis allows evaluation of trends and arithmetic relations with one or more vital signs, labs, and functions. Additional examples include MAP (mean arterial pressure), PP (pulse pressure), and CCL (creatinine clearance), each of which is related to trends in diastolic heart function and integrate with a genotype for a recommendation for ACE (ACE inhibitor). Many calculations not noted herein can be performed, thereby generating additional data sets from the data entered. Results of the analyses performed by the computational resources 19 are sent to the appropriate parties. In one embodiment, all data sets established by at least one additional mathematical computation/manipulation are part of the iVitals system learning knowledge set.

In one embodiment, a recommendation 18 is generated by the computational resources 19 based on analyzing data and data sets that are received from the secure data server 7. Recommendations may be generated by recommendation engines that may be set up by health care professionals 10 to help better inform the end user 1 of current best practices or current recommendations from certain societies (e.g., American Heart Association, American Society of Nephrology, etc.) with respect to either testing or follow up recommendations for evaluation, medication, dosage, vaccinations, etc.

Authorized healthcare professionals 10 and external researchers may also access the health data of the healthcare system 100 through the server 7. Upon proper authentication, healthcare professionals 10 are able to view the data and trends of affiliated end users 1 through web portals or mobile device applications. This review process allows healthcare professionals 10 to verify that prescribed care is being adhered to by a patient, to verify that the prescribed care is having the intended consequences, as well as to observe unintended consequences. Responses and recommendations from the review and analysis of data performed by healthcare professionals 10 and computational resources 19 are fed back to the server 7, and subsequently synced to end users 1 through the healthcare application 1A on the associated mobile devices 8. Recommendations or prescriptions (i.e., medication changes) would be sent to the end user 1.

Health professionals, physicians, nurse practitioners, and/or physician assistants may also use web access to the secure data server 7. Because this information has HIPAA concerns, encryption authentication, registration, and/or biometric authentication may also be included to record the interaction of health care professionals 10 as well as the end users 1 with the data. The secure data server 7 may also synch with a pharmacy (not shown in FIG. 1) to provide the pharmacy both updated information on the patient's current medication as well as to allow the pharmacy to evaluate certain data (e.g., liver function and renal function) that may be important to guiding the dosing determination of certain medications. For example, in some embodiments, the healthcare professionals 10 can interact directly with the server 7 to input medical information about the end users 1. For example, the healthcare professionals 10 may comprise doctors or nurses that work at a laboratory facility (i.e., blood work lab). The healthcare professionals 10 may perform the lab test on the patient and transmit the information to the server 7. In this manner, the data is not entered by the end users 1, but is instead entered by the healthcare professionals 10. In one embodiment, the healthcare professionals 10 may send a fax to a particular fax number. Imaging software may be able to read the fax and populate the appropriate fields of a patient's medical file on the server 7. In other embodiments, the healthcare professionals 10 may manually, automatically, or semi-automatically enter the data through an interface associated with the server 7. In this manner, the healthcare application 1A is operating to receive “in-patient” information, as opposed to receiving “out-patient” information from the end user 1. For example, access to the healthcare application 1A and/or mobile device 8 could be available to a nurse in the patient's hospital room. The data is transmitted to the server 7, which could then populate the hospital's medical records for the patient. By placing a layer between the nurse and the medical record (i.e., the server 7), additional data analytics can be performed to the data that is stored in the medical record. Standard medical records do not have the capability to perform data analytics in this manner.

In other embodiments, any other entity 3 that is involved in the healthcare of the end users can enter data to the server 7, such as other doctors, hospitals, lab centers, radiologists, pharmacies, or any other entities. In this manner, the server 7 functions as the crossroads and hub of different healthcare data from different sources. In one embodiment, data from different sources can be coded differently, for example, by color. In an example, Dr. X data could be color-coded blue, Dr. Y data could be color-coded purple, and data that the patient entered is color-coded green. In this manner, anyone accessing the application could know quickly where the data came from. Also, in some embodiments, different healthcare provided may be servicing a patient. The healthcare application allows the multiple healthcare providers to coordinate and send messages to one another, with a copy being sent to the patient. Also, in some embodiments, these other entities 3 can access the information about an end user stored on the server 7 and use the information to perform their healthcare duties. In these cases, the other entity 3 would need to properly authenticate to access the end user's data.

Enhanced communication (and/or engagement) to end users 1 through the healthcare application 1A comes in the form of graphical displays, as described in greater detail herein.

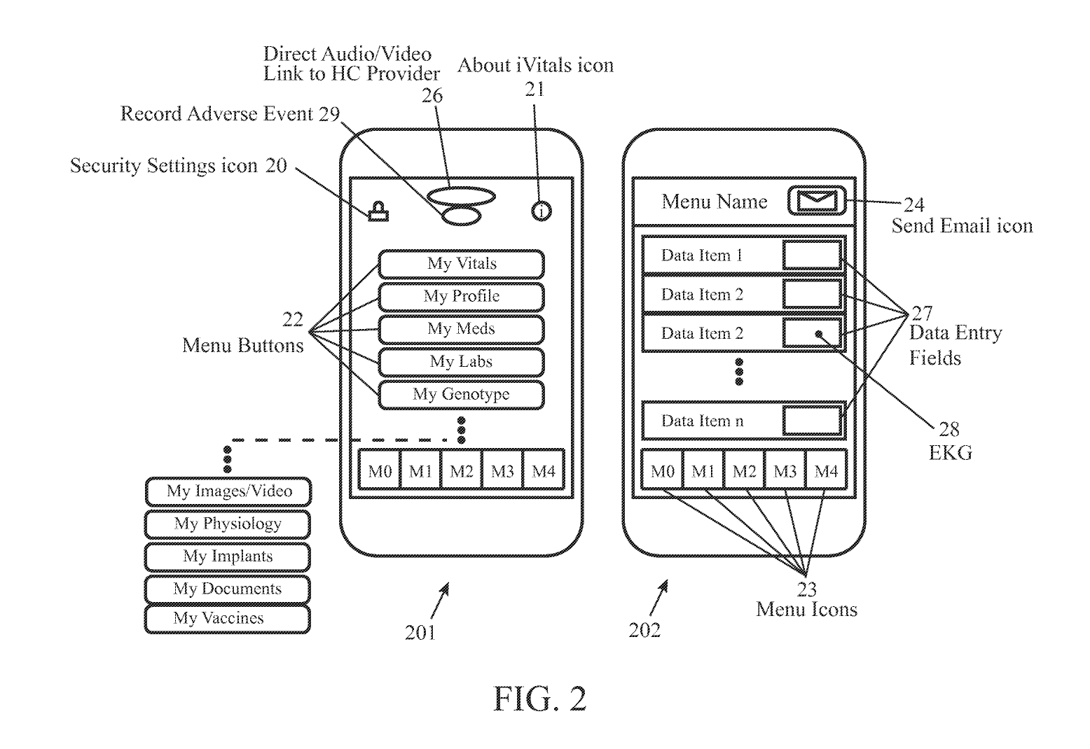

FIG. 2 is a conceptual diagram of a mobile device executing a healthcare application, according to one embodiment. In one embodiment, interface 201 is the first page shown to the user after the user logs in to the healthcare application. Specifically there may be menu buttons 22 that may include such things as vital signs, profile/problem list, medications, laboratory, blood work, blood transfusion information, pregnancy information, genotypic information, images, and physiologic wave forms. Key documents as well as key implants that are in the patient may be also included, as well as individual organ function profiles. The interface 201 may also include an “About” icon 21 that explains and allows for better understanding of frequently asked questions or video clips, and security settings icon 20 that allows the user to view or modify certain security settings.

An audio-visual connection button 26 could be used for real time interaction through audio-video applications, e.g., “FaceTime” from Apple, Inc.

An adverse event button 29 could be used for immediate recording of adverse events from medications or devices. The adverse event button 29 might be “ON” if new important adverse event information was available on the current meds or implants the user is using.

When the user selects one of the menu buttons 22, a second interface 202 may be displayed. The second interface 22 includes an email icon 24 that may enable the user to either text or email additional data information that may be collected on a certain page. Data items are entered through standard data entry fields 27 and additional menu icons 23 may be included at the bottom of this list as well.

The data entry items may include recordings from an external device. For example, an EKG may be connected to the mobile device and EKG data 28 is entered in the interface 202. The data entered in the interface 202 is sent for evaluation either within the device or to the data server where it could get additional data evaluation.

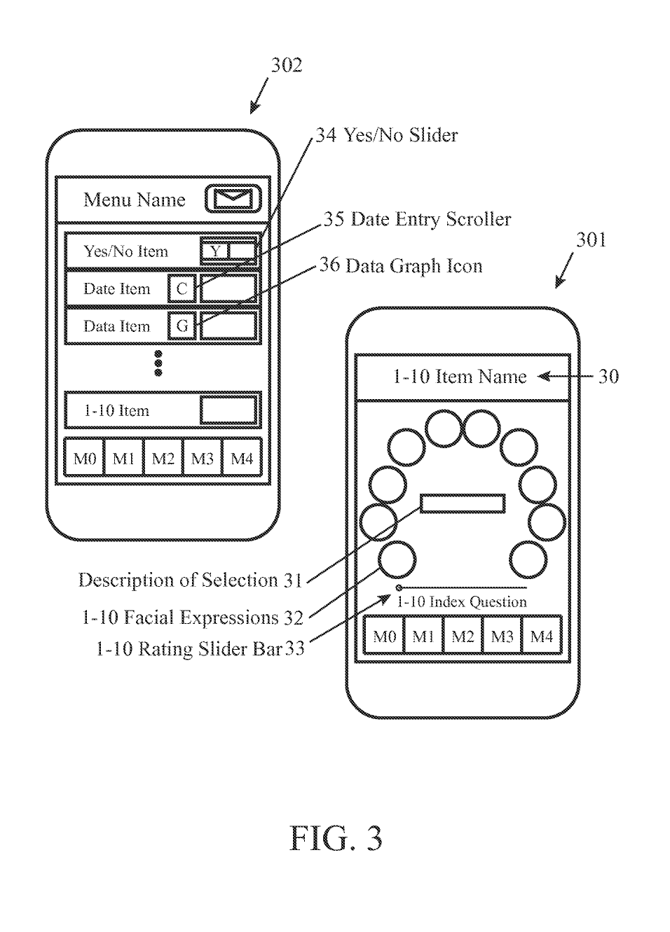

FIG. 3 is a conceptual diagram of data entry alternatives for specialized data elements, according to one embodiment. Much medical information has scales as a simple way to evaluate medical conditions (i.e., Glasgow scale 1-15). Interface 301 may be used to enter data elements on a scale, e.g., a scale from 1 to 10. A name 30 for a data field is shown with a description 31. Facial expressions 32 may correspond to different ratings 33 of the data field. Examples include a mood index, a pain index, a shortness of breath index, a CIWA scale, an index of neurologic function, or an index of agitation, depression, anxiety, etc. A rating slide bar 33 allows the user to be able to customize the input and allows the user to have a better understanding of how that scale might fully be best understood.

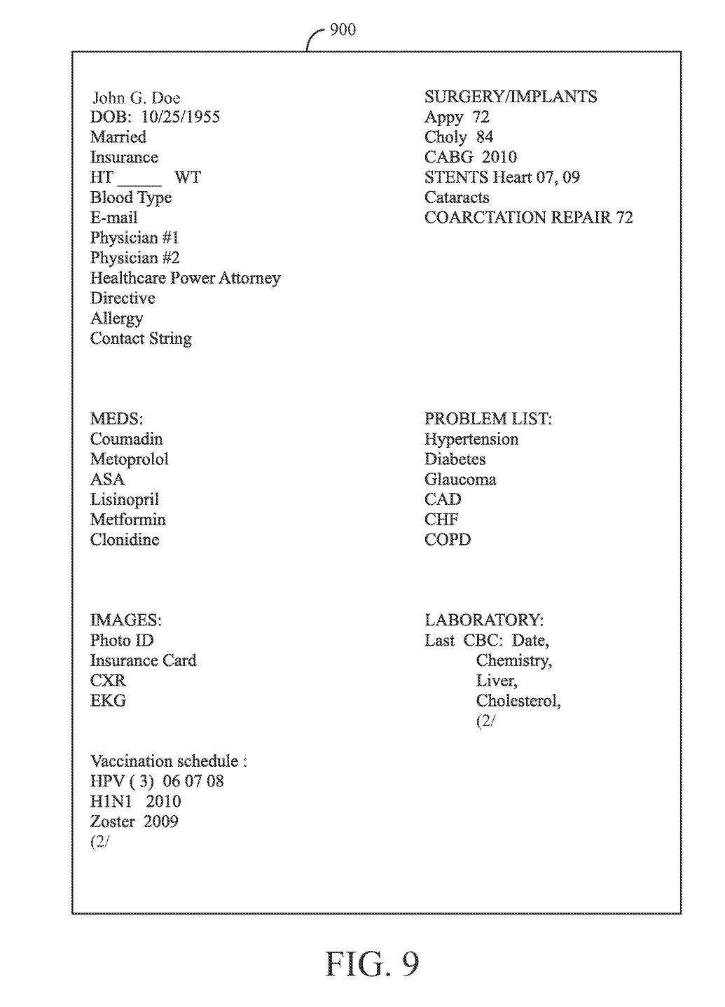

FIG. 3 also shows interface 302, which may be an example of an event recorder interface or a problem list. The interface 302 may include a Yes/No slider 34, a data entry scroller 35, and/or a data graph icon 36. A problem list might have a diagnosis-specific code that might be utilized to understand better the medical condition of the patient. For example, such an interface 302 may be utilized to indicate a medical visit, such as an emergency room (ER), hospital, or office visit. In another example, the code is associated with a specific disease, e.g., diabetes. In different embodiments, the codes can be entered manually and/or automatically depending on the problem or event. The interface may provide a timeline to better understand when somebody was hospitalized and for what reason. The problem list 24 may also be included in a summary sheet, described below in FIG. 9.

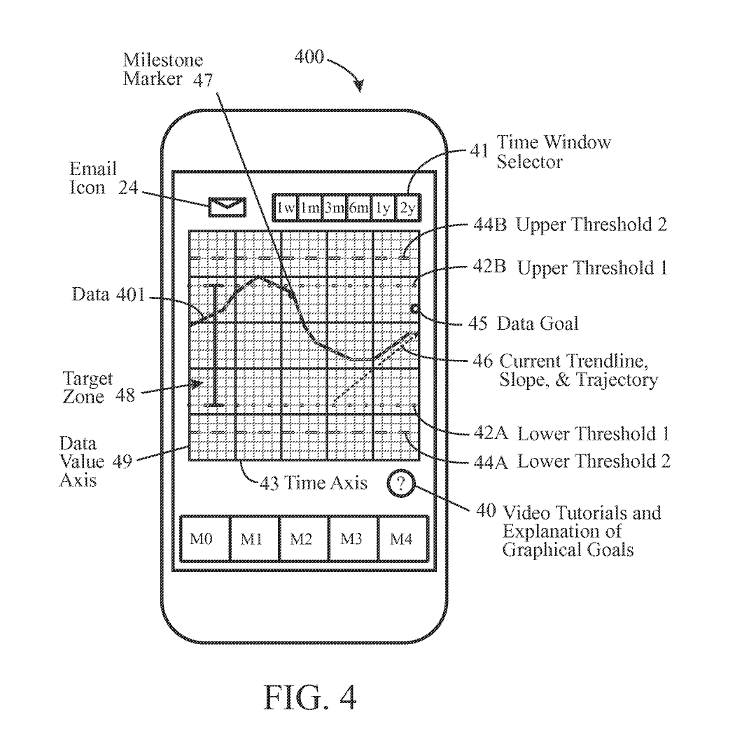

In one embodiment, selecting data graph icon 36 causes a graphical representation of the data elements to be displayed. FIG. 4 is a conceptual diagram illustrating a graphical representation of data elements, according to one embodiment. The graphical representation of data elements can be made available to end users on mobile devices and healthcare professionals through those mobile devices as well as web portals. The graphical representations may include a number of different comparisons and multidimensional evaluations with different variables on multiple axes: X, Y, Z, A, B, C, etc.

In one embodiment, interface 400 includes an email icon 24, video clip button 40, time window selector 41, thresholds 42A-42B, 44A-44B, a goal 45, a trend line 46, a milestone marker 47, a target zone 48, a data value axis 49, a time axis 43, and data 401. Data 401 is plotted on a graph having a time axis 43 and a data value axis 49.

Email icon 24 may be used to email information or text the information. Time window selector 41 selects a timeline that is used to evaluate the data and visualize the data. Milestone markers 47 may be utilized to create certain points of information to the patient and points of discussion. Target zones 48 are created between threshold 42A-42B or 44A-44B with respect to a data goal 45. Trend lines 46 are evaluated are also displayed. The data may exist in multiple colors, for example red, yellow, or green, as a way of better understanding the data getting closer to target zones and target goals. The data visualization may include an audio-visual component that again allows better understanding and encouragement of true goals.

A video clip button 40 may also be included in interface 400 to give users short video presentation of how this data might best be interpreted and to remind the user of the specific target zones and target goals and why those are important. These videos might instruct on the reason and need for these goals.

In some embodiments, visualization of data over time relative to thresholds 42A-42B, 44A-44B, target zones 48, and goals 45, and the trends 46, or rates of change, of data with appropriate feedback, engages the end user in monitoring and improving their own health. This graphical representation of health data allows the user a unique understanding of his/her health. This may cause improved compliance with health recommendations and lower health costs. By capturing repeated observations of the data elements, the healthcare system 100 is able to compute trends over varying time scales 41. The scope of both the range of data collected and the range of communication with end users allows the healthcare system 100 to administer healthcare services without the need for ancillary encounters. Recommendations to both the user and healthcare provider may be provided in real time with full integration of medications, lab work, vital signs, vital functions, and genotypic information.

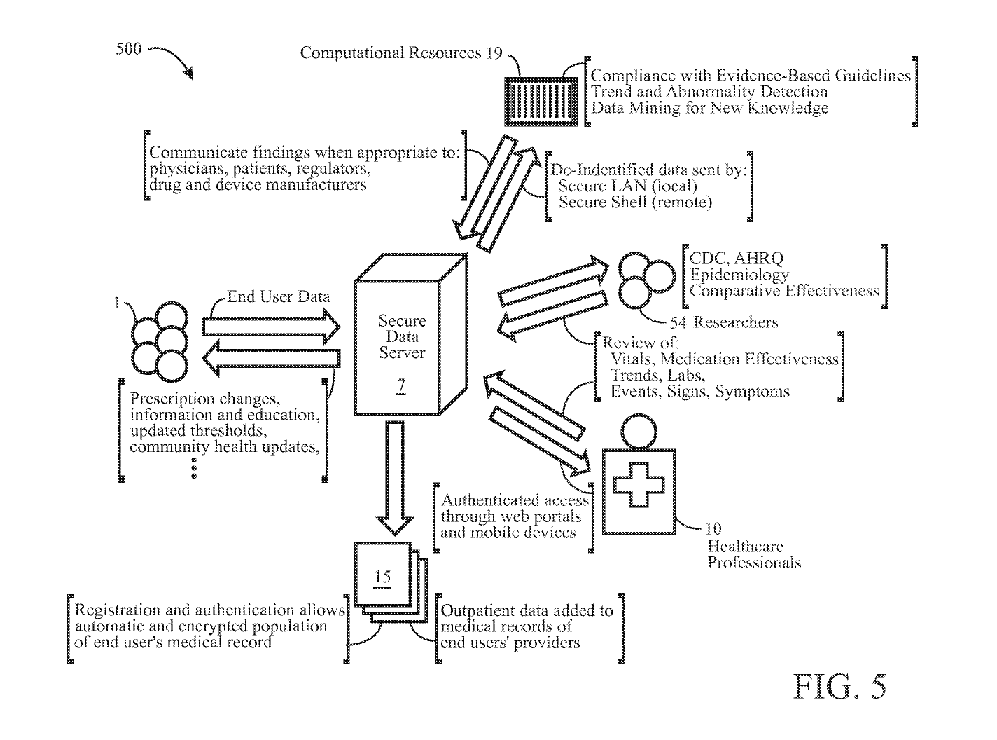

FIG. 5 is a conceptual diagram illustrating back end functions of a healthcare system 500, according to one embodiment. The healthcare system 500 includes end users 1, a server 7, medical records 15, healthcare professionals 10, researchers 54, and computational resources 19. End users 1 provide data to the server, e.g., via the healthcare application 1A in FIG. 1. The server 7 communicates findings to one or more of healthcare professionals 10, researchers 54, and computational resources 19. The healthcare professionals 10, researchers 54, and computational resources 19 can review the data and provide a response to the server 7, which can then be communicated by the server 7 to the end users 1. The data receiver from the end users 1 and/or the responses received from the healthcare professionals 10, researchers 54, and/or computational resources 19 can populate medical records 15.

Allowing health care professionals 10 to access the secure data server 7 and allowing researchers 54 (e.g., from an infectious disease or epidemiologic or quality care perspective) may allow for the data to be depersonalized and viewed in aggregate. For example, the data can be evaluated to determine certain trends and can provide for great healthcare tools for health care professionals 10 and researchers 54.

Computational resources 19 provide the opportunity to data mine for new knowledge. The computational resources 19 can evaluate trends, issue flags when certain conditions are detected, inform healthcare professionals 10 of these findings, inform as end user of these findings, and evaluate current information, laboratory data, medications, and the entire data user experience to find whether current evidence-based guidelines are being utilized and if not, how recommendations might be changed to ensure better health care evaluation through those recommendations. Improved healthcare means adhering to “best practices” and best current knowledge. This knowledge generates goals, targets, and target zones for where our individual health should be. New knowledge, like genomics, could also generate additional recommendations to individualize drug and medication recommendations for individual patients.

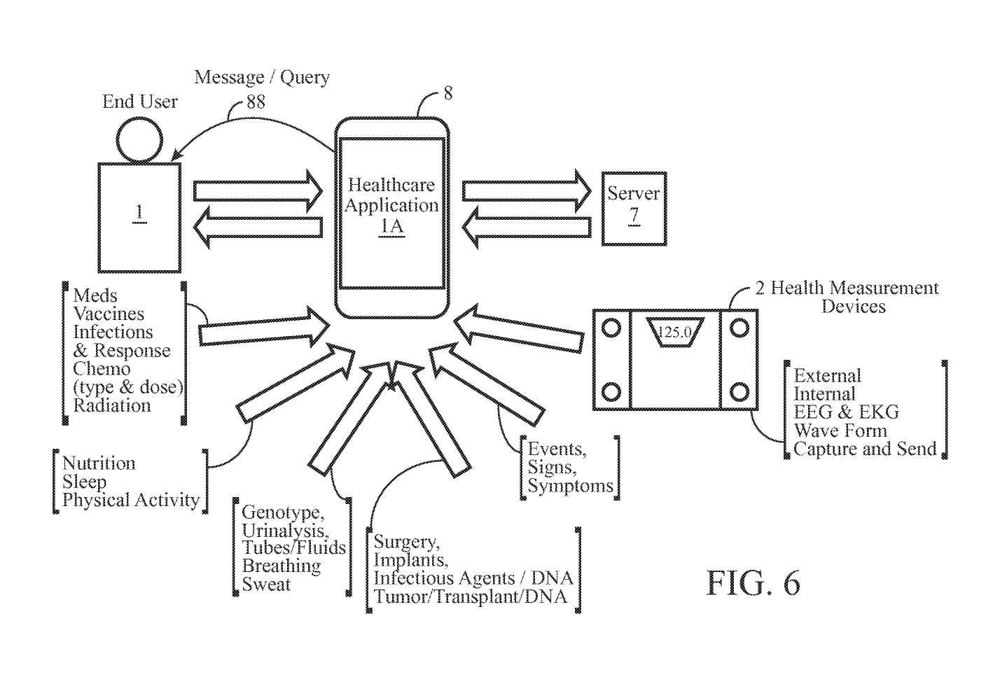

FIG. 6 is a conceptual diagram illustrating how data is entered into a healthcare application 1A, according to one embodiment. As described herein, the healthcare system 100 takes into account laboratory data, blood work, vital signs, medications, etc. The healthcare system 100 also takes into account evaluation of heart and lungs, brain and kidney function, in addition to genotypic information. The healthcare system 100 includes adverse events like infection and exposure to radiation, as well as standard data sets like vaccinations and surgical implants. The mobile device 8 is also intended to provide the ability to include data from individual users. More examples include the ability to enter data on urinalysis, breath data, and sweat data. Nutrition, sleep, and physical activity can also be similarly recorded. Chemotherapy types and chemotherapy doses can be recorded, as well as amounts of radiation. Sleep cycles might best be recorded by using the alarm and asleep clocks as well as an AM query on the night's sleep.

The mobile device 8 running a healthcare application 1A would have the opportunity to ask the end user 1 through text and/or voice commands or a voice query 88 whether the patient has taken medications and/or required a refill on a prescription. This allows the healthcare application 1A the opportunity to better understand medical compliance and also to provide medication reminders to the patient. The voice query as well as a message query could be sent to the end user 1, where the user's responses are utilized to gauge the appropriate compliance with physician recommendations. In addition, the healthcare application 1A would have the opportunity to record the voice of the end user 1 and to ask provocative but simple questions, such as “How did you sleep?” or “How are you feeling?” The responses would then be typed into a search database that may subsequently ask or make recommendation for vital signs, vital labs, or specific visits or interactions with health care providers.

Events, signs, and/or symptoms could also be sent to the mobile device 8 running the healthcare application 1A. Standard health care measurements including both external and internal measurements could be utilized and sent to the mobile device 8.

Additional information might include, for example, tumor data information including tumor genotype and DNA and drug susceptibility as well as genotypic and phenotypic information of tumors to better characterize both tumors and the patient's normal cells and physiology. Transplant DNA/RNA/genotypic information could be entered to help evaluate best strategies for immune suppression or chance of rejection. Similar DNA/RNA/proteins/enzymes information could be entered from infectious agents.

Other types of data or techniques for providing the data to the healthcare application 1A are also within the scope of embodiments of the invention.

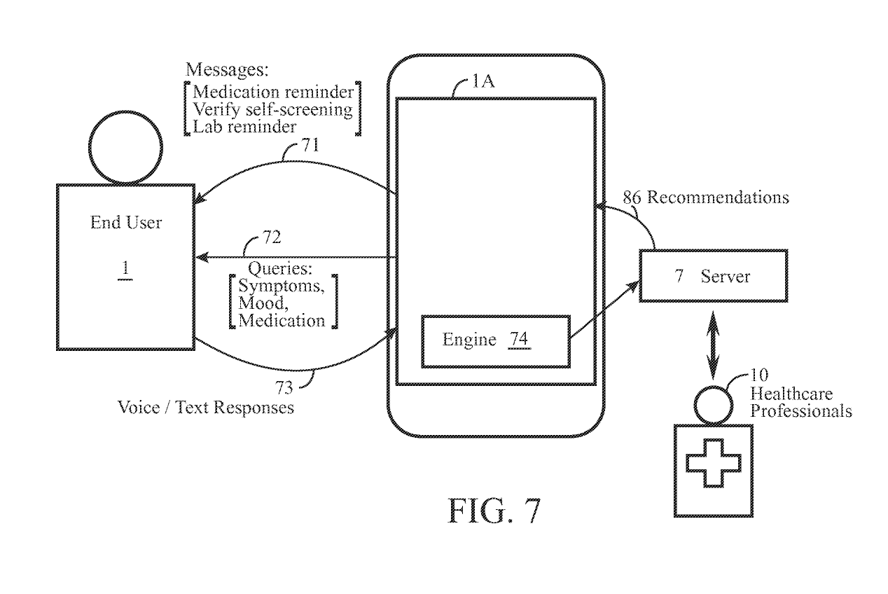

FIG. 7 is a conceptual diagram illustrating how a healthcare application would query or send messages to users, receive responses, and record those responses on a server, according to one embodiment. In other embodiments, the healthcare application might analyze voice characteristics as well as answers. Messages 71 (e.g., medication reminders, verifications of self-screening, or lab reminders) or queries 72 (e.g., symptom query, mood query, or medication query) can be transmitted from the healthcare application 1A to the end user 1. The end user 1 can respond to the messages 71 or queries 72 by issuing responses 73, either voice or text or both.

An engine 74 included in the healthcare application 1A is configured to receive the responses 73 and parse the voice and/or text. The responses are then transmitted to the server 7. The server 86, with or without the help of computation resources 19, may determine recommendations 86 based on the responses 73. The recommendations 86 are communicated to the healthcare application 1A, which in-turn communicates them to the end users 1.

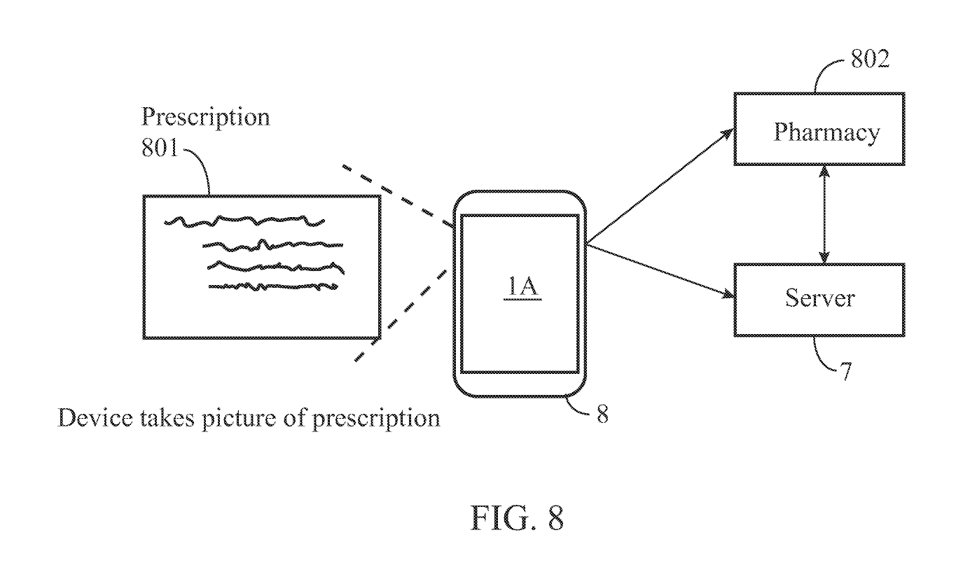

FIG. 8 is a conceptual diagram illustrating how a healthcare application 1A interacts with prescriptions 801 and/or a pharmacy 802, according to one embodiment. The healthcare application 1A can utilize a camera included in mobile device 8 to take a picture of a prescription 801. The picture of the prescription 801 is then parsed for information. The information is sent to a pharmacy 802 and/or server 7. The pharmacy 802 may interact with server 7 to authenticate the prescription. The pharmacy may then take various actions, such as refilling the prescription. Also, in some embodiments, the pharmacy 802 may interact with server 7. In these embodiments, the pharmacy 802 could be the source of data about an end user/patient that is stored on the server 7. For example, the pharmacy 802 could populate a medication list of an end user/patient on the server 7. FIG. 8 might also incorporate the concept of camera as generator of photos of medical images. This allows Images section in the healthcare application to be populated with baseline critical medical images, such as last EKG, last CXR, etc. This data could be secured in cloud server as well.

FIG. 9 is a conceptual diagram illustrating a summary 900 of a user's profile, according to one embodiment. In one embodiment, the summary 900 can fit on one sheet of paper when printed. According to various embodiments, the summary 900 can include current medications, a current problem list, current implants and surgery, current images, current vaccinations, current allergies, last known vitals, and/or labs. The summary 900 could have a biometric ID (e.g., photo, fingerprint, etc.) and insurance information. In some embodiments, the summary would allow a quick and complete registration of the user, e.g., to a new doctor or hospital. The summary 900 can be created by the healthcare application 1A based on the various pieces of data that have been accumulated from various sources by the healthcare application 1A.

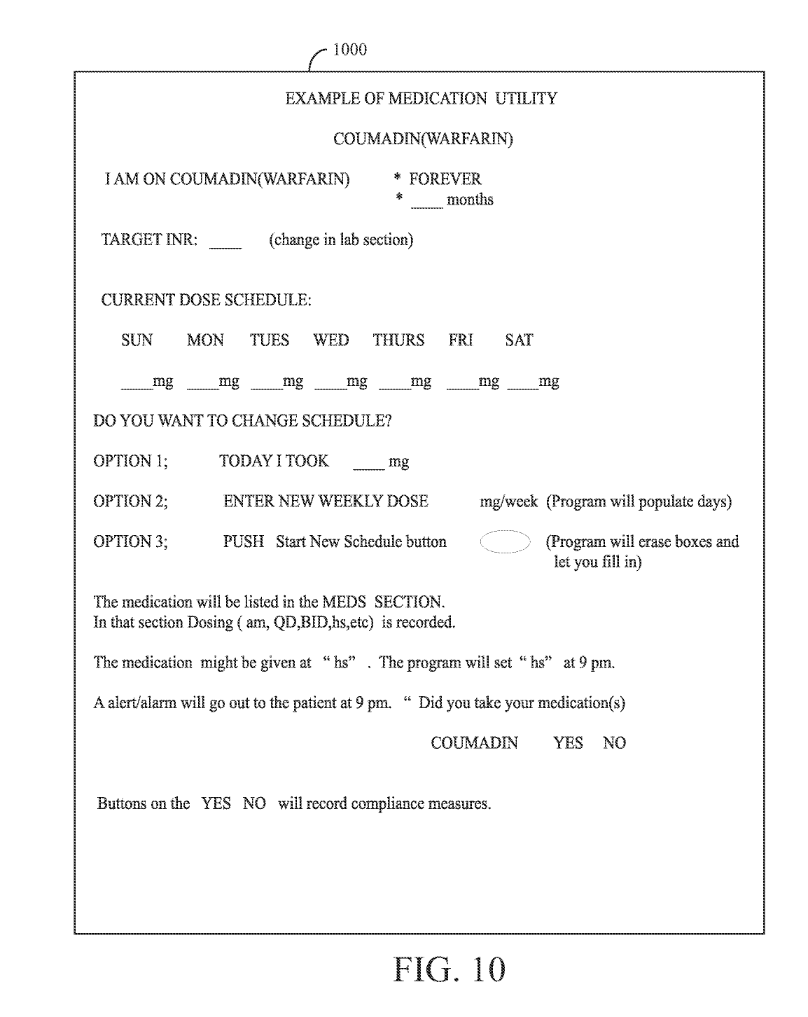

FIG. 10 is a conceptual diagram illustrating a medication/pharmacy module 1000 associated with a healthcare application 1A, according to one embodiment. This module 1000 can be generated by the healthcare application 1A and would allow the ability to recalculate medication dosing for those medications that need frequent changes based on lab values or kidney/liver function. Coumadin dosing (as represented in FIG. 10) is just one example.

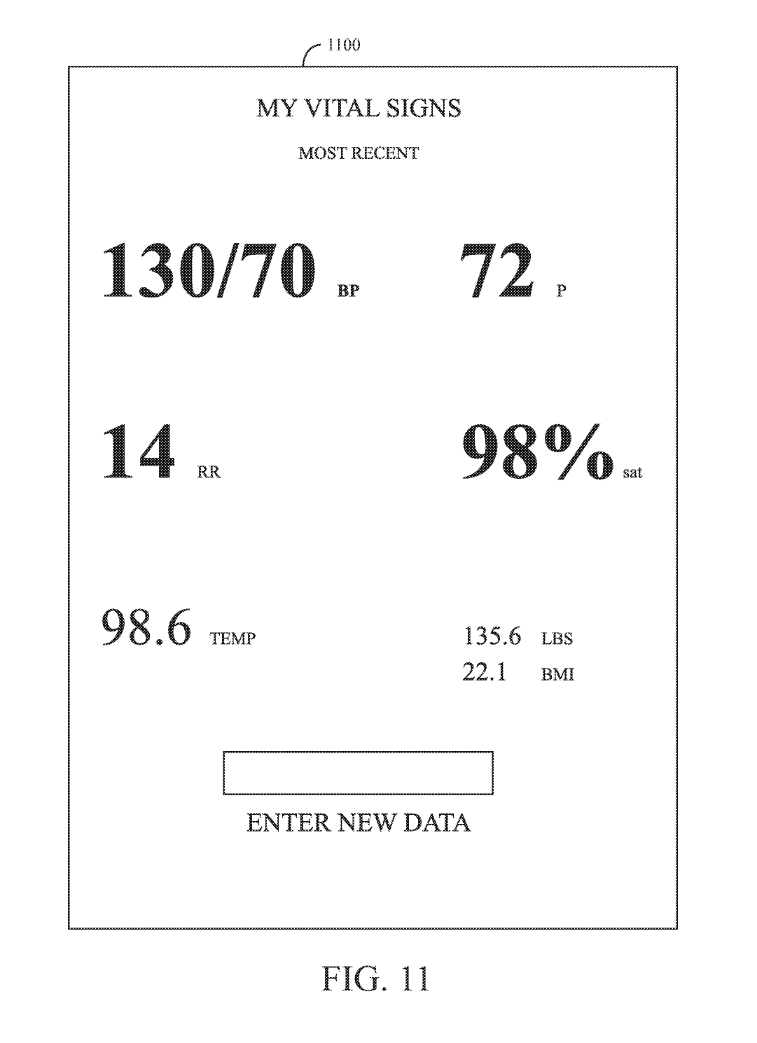

FIG. 11 is a conceptual diagram illustrating an example of a first page 1100 of a healthcare application 1A designed for elderly patients, according to one embodiment. Larger text and/or larger images may be displayed. The text and/or images can be selected by the user and/or patient to record (via text or voice or other) new data. With text input, the numbers/letters for selection may be larger than in a normal operating mode.

In sum, embodiments of the invention provide a healthcare system and healthcare application that can be used to aggregate data about an individual. Aggregation of the data allows for a better understanding of the physiology of the individual and allows for the better medical treatment to be given for the individual patient. Rather than relying on general recommendations for certain metrics (such as ideal body weight, blood pressure range, etc.) the data can be analyzed and may allow specific recommendations for best medications for this person's particular physiology that allows good renal function and preservation of cardiac or lung function. For a particular individual, this recommendation may occur at a different weight and blood pressure than would normally be recommended. This is called “personalized healthcare” and is directed by the physician or other healthcare provider based on recommendations from complex data (using complete data sets and “best clinical practices”).

In addition, any medication changes are automatically synced to the server and healthcare application, providing for the most up-to-date information. All of the various data elements received by the healthcare application 1A may assist pharmacies and healthcare providers in medication dosing and interactions with other medications.

### Installation and Communication

The healthcare application described herein resides in the memory of a mobile device. Candidate mobile devices included, but are not limited to, personal computers (e.g., laptop, desktop), mp3 players, smart phones, and tablet computers. The healthcare application can be installed and updated by physical (e.g. universal serial bus (USB) adapters) or wireless (e.g. Bluetooth, Wi-Fi (IEEE 802.11), near field communication (NFC), or 2G/3G/4G telecommunication networks) connections to desktop computers, cloud-based application markets, and other mobile devices. In the case that an end user uses more than one such mobile device, the healthcare application can be installed on each device. In such circumstances, data entered to any one of the devices is automatically synced to the other devices.

Data entry into the healthcare application can be performed manually or automatically by linking to and downloading data measurements from health measurement sensors embedded in the mobile device itself and peripheral data measurement devices. An example of a measurement that would need to be entered manually would be a self-assessment of mood. An example of a sensor embedded in a mobile device would be a camera lens to photo a rash, face, CXR, EKG; another sensor (Bluetooth or RF) might measure heart rate and variability. Peripheral health measurement devices include home-based (e.g. scales, thermometers), office-based (e.g. blood pressure meters), laboratory equipment (e.g. flow cytometer, urinalysis, genotyping) and even embedded sensors (e.g. blood sugar monitors, pacemakers). The connection between peripheral measurement devices and the mobile device where the healthcare application is stored can be made physically by USB and other cables, or wirelessly via Bluetooth, Wi-Fi, NFC, infrared data association (IrDA), wireless USB, Z-Wave, ZigBee, or 3G/4G wireless networks. In particular, the healthcare application is intended to communicate with the gambit of health measurement devices in the end user's wired or wireless personal area network (PAN). In some embodiments, one or more data items associated with an end user that are transmitted to the server 7 include a datestamp, a timestamp, GPS (global positioning system) location information, and/or any other technically feasible information. For example, when data measurements are made in real-time, the healthcare application can couple measurements with the GPS coordinates and/or local temperature readings from the mobile device's operating system. Data that is entered into the healthcare application is stored in the memory of the mobile device and encrypted for security purposes.

In one embodiment, data is time-stamped and location-stamped (for example, GPS). Some data, where appropriate, has authentication tools. In some embodiments, a calendar with time lines, day, week, and month helps secure timeliness of interactions with health care providers, testing, as well as therapy, for example. Better visualization has value for all providers to understand timeliness of other medical consultations.

Authenticating certain data sets allows better health documentation. For example, a pharmacy may offer flu shots. When a patient receives a flu shot at the pharmacy, the pharmacy stamps the patient's healthcare application with the flu shot info, such as, for example, model, bin, serial number, etc., and then that shot was given and where/when.

### End User Operation of the Healthcare Application

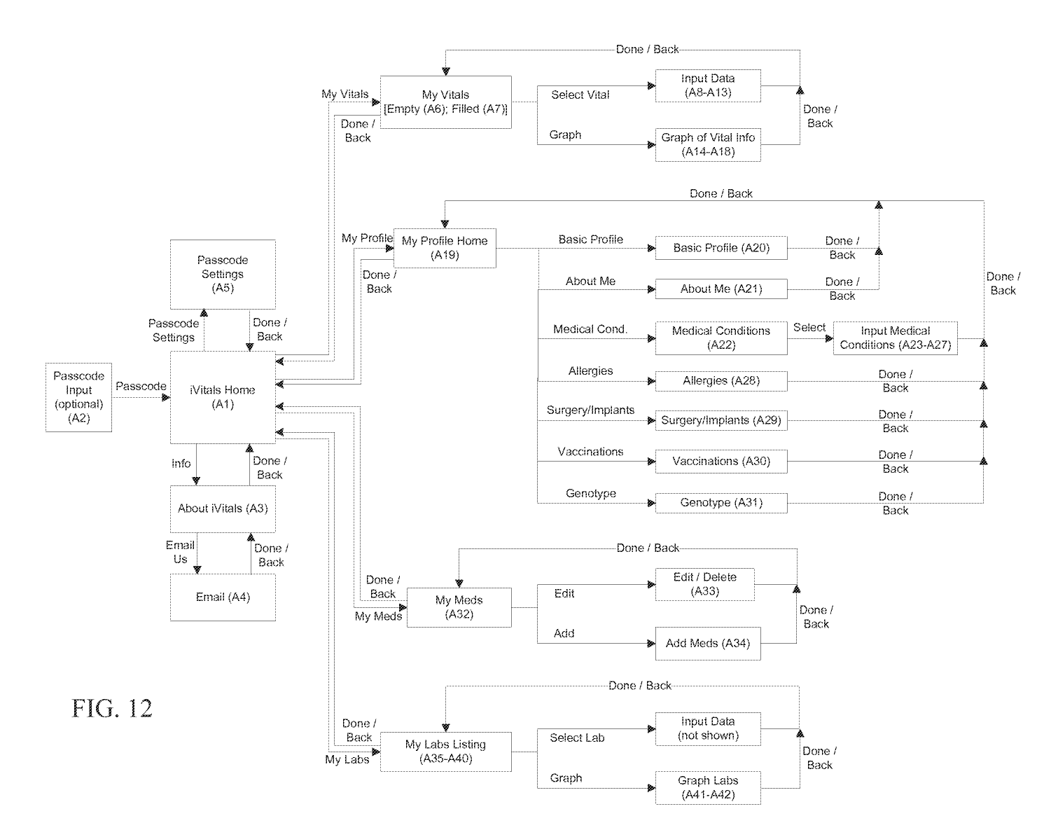

FIG. 12 is a conceptual diagram illustrating a user workflow of a healthcare application, according to one embodiment. Additionally, screen shots of example images of the healthcare application are included in the Appendix to the Specification and are numbered Image A1 to Image A42.

As shown in the Appendix to the Specification and in FIG. 12, the healthcare application comprises a series of screens that can be navigated by an end user. Upon start-up, the healthcare application takes the user to a home/welcome screen (Image A1). Optionally, the end user may first be required to enter a passcode via passcode input (Image A2). The primary features of the welcome screen are: a number of main menu buttons linking to the other main menus, a security settings icon, and an “About/Info” icon. The About/Info icon, when selected, links the user to detailed information about the healthcare application such as: the current application version number, an overview of the capabilities and purpose of the system, frequently asked questions, the names of the software creator, developer, and designer, an email address for support and communication, and copyright information (Image A3). The user can click on an Email Us link to send an email to the healthcare application developer, e.g., feedback or usability requests (Image A4).

The security settings icon, when selected, allows the user to setup new and change existing login ID's and passwords for multiple end users on a single mobile device (Image A5). The purpose of multiple login ID's is not only to allow for multiple users to utilize the healthcare application from a single mobile device, but also to allow varying levels of access to each of the user profiles. For example, the principal user would have both read and write privileges, whereas other users may only require reading or writing privileges. Once a security password is established, the healthcare system prompts the end user for a login ID and password upon start-up. The healthcare application may also make use of advanced identification methods such as facial recognition or other biometric identification.

In this example, the four main menus at the welcome screen include: My Vitals, My Profile, My Meds, and My Labs. Also, in some embodiments, at the bottom of every screen within the healthcare application, are icons which link the end user to the main menus of the healthcare application. Also, in some embodiments, on each of the four main menu screens (excluding the welcome screen) the user has the option of sending an email using the mobile device's standard email client to any email address by clicking on the send email icon. The primary email addresses stored by the healthcare system are those of the end user, the end user's primary care physician (PCP), and those of healthcare providers (e.g. pharmacies and labs) the end user utilizes. By clicking on the send email icon, one embodiment would present the end user with a form for email correspondence. The form could include a drop down menu of the email addresses stored by the healthcare application, standard subject and message fields, and another drop down list which allows the end user to select which data elements to attach to the email.

Data elements are grouped within data input screens located in the main and sub-menus of the healthcare application. The general format for data input screens throughout the healthcare application is seen in Image A6, correspond to the My Vitals. Data elements are listed in rows with the name of the data element on the left and the data entry field on the right. When entering data manually, clicking on a general data entry field presents the end user with an alphanumeric keypad to enter the data observation. Before the first observation is recorded for any data element, translucent gray text may appear in the data entry field to prompt the user as to the type of data required by the data element. For example, the data element blood pressure, which appears in the My Vitals data sheet, prompts the user to enter blood pressure (mm/hg) in the format of “systolic/diastolic.” When presented with an alphanumeric keypad, the user has the option of dictating the data to be entered, which can be recognized by the devices microphone, and converted using voice-to-text algorithms. Bluetooth acquiring of BP, Pulse, O2 sats, weight, and labs (from imbedded sensors) may be used to enter the data.

Besides the standard alphanumeric keypad, there are several specialized data entry prompts. Several of these alternative prompts which are presented to the end user for entry of specialized data fields can be seen in FIG. 3. For data elements which require a yes or no response, the user sees a Yes/No Slider. The two alternatives are color-coded choices to visually contrast yes and no responses and the user moves the slider to the appropriate response. An example of a data element which elicits a yes or no response from the user is the “eye glasses” prompt from the About Me data input screen found in the My Profile menu. For data elements that require a date response, a calendar icon appears next to the data entry field. Upon clicking on the calendar icon, the end user is presented with a scrolling input prompt for the month, day, and year of the data observation being entered.

When entering an observation for a data element that is captured on a 1 to 10 scale (see FIG. 3), the end user is taken to a screen such as in the right panel of FIG. 3. This data entry screen is intended to improve the reliability and accuracy of the observation self-recorded by end users. The screen shows 10 facial expressions meant to capture the each rating level (IMAGE 21). For each selection, the screen presents a word or phrase description of the selected level. For example, for the data Pain Index data element, the level 1 selection is described as “No Pain”, the level 7 selection is described as “Debilitating Pain”, and the level 10 selection is described as “Worst Pain Possible”. The end user can record an observation by either selecting the appropriate level (expression), or by sliding the rating slider bar, which allows a finer granularity (e.g. the end user could select a rating of 3.5 by using the slider bar). Future embodiments may include other specialized data entry formats (Fall, Glasgow, or other indexes). For example for observations which are particularly weather or altitude dependent, the end user may be prompted to select the approximate recording location from a map. Altitude and weather observations could be paired with this information from online resources.

Any data entry, whether manual or automatic, stamps the observation with identity of the entity making the entry. This stamp could be an end user ID, end user PIN, biometric or other device registration number.

In the listing the data sheets and data elements captured by the healthcare application, an inclusive list is presented. That is, capabilities of the healthcare application are not limited to the data elements listed. The data elements are described relative to the healthcare application user, who is taken to be an end user of the healthcare system.

The My Vitals button and the My Vitals icon link to the My Vitals screen (Image A6). Data elements captured on the My Vitals screen include heart rate, blood pressure, weight, height, temperature, respiration, oxygen saturation, shortness of breath, and pain and mood indices. BMI, BSA, MAP, PP as well as Creatinine Clearance are calculated from My Vitals data. Vital signs may also be recorded as a wave form (i.e., blood pressure, pulse, EKG, EEG, ICP, etc.) with more robust information.

In one embodiment, the fields on the My Vitals screen may be empty or may be populated to default or previous values. A user can select one of the data elements to enter data for that data element. Examples of data element input screen are shown as Images A8-A13. An example of a completed My Vitals screen is shown as Image A7.

As also shown in Image A7, a graph icon is included next to each data element. When the user selects a graph icon, a graphical representation is generated for that data element. Examples of data element graphical representations are shown as Images A14-A18.

The My Profile button and the My Profile icon link to the My Profile screen (Image A19). The My Profile screen includes sub-menus for Basic Profile (Image A20), About Me (Image A21), Medical Conditions (Image A22), Allergies (Image A28), Surgery/Implants (Image A29), Vaccinations/Infections (Image A30), and Genotype (Image A31). In some embodiments, an additional IMAGES section could exist in this location as well with photos/videos/recordings of critical medical images (for example, EKG, CXR, echo, ultrasound, CT, MRI, among others).

The Basic Profile data sheet (Image A20) records basic identification and demographic elements of the user including name, gender, weight, date of birth, zip/postal code, country, marital status, and email address. The Basic Profile data sheet also captures identifier elements of the user's PCP including name, phone, fax, email address, and unique physician identification number (UPIN).

The About Me data sheet (Image A21) has yes or no questions related to general health and behavioral data elements including whether or not the user: requires dialysis, has HIV, has cancer, is on steroids, is on oxygen, is on Coumadin, is pregnant, has had a transplant, requires eyeglasses, smokes, has quit smoking, and drinks Following up yes responses, the device records pertinent data such as when the user began dialysis, how many liters per minute of oxygen the user consumes, what the user's target international normalized ratio (INR) level is, what the user's right and left eye prescriptions are, how long the user has been smoking, how many packs per the user smokes, and how many drinks the user consumes per day and week.

The Medical Conditions (Image A22) link presents a sub-menu of data sheets which capture detailed health information about various conditions. This sub-menu is shown as Images A23-A27. The Diabetic data sheet captures when the user was diagnosed with diabetes, whether the user has Type 1 or Type 2 diabetes, whether the user uses an insulin pump, and whether the user checks blood sugar on an AM/PM schedule or with each meal. The High Blood Pressure (HBP) data sheet records when the user was diagnosed with HBP, whether the user's HBP is well-controlled, whether the user has had or has a family history of stroke, whether the user has a family history of HBP, whether or not the user has kidney stones, infections, or failure, and whether the user requires dialysis. The Heart Disease/Failure data sheet (IMAGE 9) records whether or not the user has had: a myocardial infarction (heart attack), congestive heart failure (CHF), irregular rhythms (atrial fibrillations), heart stents implanted, pacemaker/automatic implantable cardioverter-defibrillator (AICD) implanted, heart valve replaced, and data on the user's last echocardiogram. The Lung data sheet (IMAGE 10) captures whether or not the user uses: oxygen at home, inhalers, a bi-level positive airway pressure (BIPAP) mask for sleep apnea, or oral steroids, and whether or not the user has been diagnosed with chronic obstructive pulmonary disease (COPD), emphysema, bronchitis, or pneumonia. The Cancer data sheet records the elements for multiple cancers including the organ(s) affected, the date of discovery, the type and data of surgeries, and whether the user receives chemo or radiation therapy. The Brain/Neurology data sheet captures whether the user has been diagnosed with: stroke, brain bleeding, Alzheimer's/dementia, multiple sclerosis (MS), depression/psychosis, mental disability, and whether the user has undergone brain or carotid neck surgery. The Arthritis/Joints data sheet records whether the user experiences back or other chronic pain, and whether the user takes anti-inflammatory medication or injections for pain. The Arthritis/Joints data sheet also records the types and dates of multiple surgeries. The Blood data sheet captures whether the user has: bleeding tendencies, anemia, lymphoma, leukemia, malaria, sickle-cell disease, HIV, or other blood disorders. The Transplant/Other Conditions data sheet records whether or not the patient has failure or cirrhosis of the liver, gastroesophageal reflux disease (GERD), or thyroid medication, and the organs and dates of multiple transplant operations.

In some embodiments, the Medical Conditions section of the healthcare application is where a patient problem list is created and where patient and his doctor might share the current list of medical problems. A problem list generated by evaluating multiple medical diseases like this could also be part of a Summary page useful as a registration tool as well as for patient and doctor to understand together.

The Events/Signs/Symptoms data sheet allows the user to input data that in many cases is not directly or precisely measurable. For example, new symptoms and/or new signs can be recorded in voice text or images. This is an example of were the application serves as the Virtual Patient, i.e., as a record of all health changes. An example of an adverse event could be a description of a sports injury, such as a knee sprain. The data for this adverse event could include written and audio descriptions of the event itself, as well as the subsequent symptoms. Picture and video attachments, such as video of the end user's abnormal gait with the injury, could be also attached. An example of a sign would be a rash, bruise, discoloration, cold toes, etc. Examples of symptoms include dizziness, slurred speech, nausea, vomiting, severe nausea after taking a medication, for example. Data on signs and symptoms could be entered with text, audio, still images, and/or video. In some embodiments, the data entered is time stamped, location stamped, and may have a registration code (when not entered by the patient).

Referring back to the My Profile screen, the Allergies data sheet (Image A28) allows the user to input allergies including multiple food allergies, medication allergies, latex allergies, and other miscellaneous allergies. A list of drugs, foods, or other substances without true allergy, but recorded reactions, could also be recorded.

The Surgery/Implants data sheet (Image A29) allows the user to add as many surgeries or implants as necessary. For each operation, healthcare application records the name of the procedure performed, the date, the attending physician, and the hospital or care facility. If the operation was an implant, the user additionally can enter the manufacturer, model number, model name, and serial number of the implant. Surgical procedures where the anatomy is deleted, removed, or altered could inform the 3D model of the Virtual Patient. Devices, grafts, and instrumentation along with staples and other hardware could also be recorded in the 3D model of the virtual patient.

The Vaccinations/Infections data sheet (Image A30) prompts the user for type, date, lot number and vaccine manufacturer, for multiple years of vaccinations including influenza, H1N1, PNEUMOVAX, tuberculosis, tetanus and diphtheria, Hepatitis A/B/C, Human Papilloma Virus (HPV), Measles, Mumps, and Rubella (MMR), Rabies, BCG, Varicella, and Zoster. The infections part of the data sheet records whether or not the user has had various infections including: tuberculosis, chicken pox, measles, mumps, rubella, herpes, HIV, MRSA, shingles, CMV, Hepatitis A/B/C, Malaria, and Polio. Additional data entry in a section like Vaccinations allows scanned bar codes of vaccine information (e.g., vaccines delivered) to automatically populate the Vaccinations section. The Vaccinations/Infections data sheet can also be configured to record DNA and genotypic information.

The Genotype data sheet (Image A31) prompts the user for genotype information. As medical knowledge with respect to genetic makeup becomes more complete, genotype information is expected to play an increasingly large role in the understanding and definition of best clinical practice. For example, care can be improved as genetic markers are discovered which identify individuals as being at high risk for developing heart disease or diabetes. Today we understand drug selection for treatment is improved when we understand individual genotypic information. Similarly, gene therapy information could be recorded.

The My Meds button and the My Meds icon link to the My Meds screen (Image A32). At the My Meds screen, the user can edit or delete medication records (Image A33) or add (Image A34) a medication record. Each medication record stores the medication generic and trade names, the amount and frequency of dosage, the reason for medication, the prescribing physician's name and UPIN, any adverse reactions experienced, and other notes. Route of administration is also recorded. For each medication entered, the healthcare application prompts the user to setup reminders based on the medication frequency. The medication reminders sync with the calendar from the mobile device's operating system. The healthcare application also generates automatic prompts to assess whether or not the end user has complied with the prescribed dosing and frequency. Alerts to take the medication and an adherence module to ascertain compliance are important aspects of this IP.

The My Labs button and the My Labs icon link to a data sheet where the user enters results from laboratory and home-based tests (Images A35-A40). Included in the labs captured in this sheet are blood sugar, hemoglobin (HBG A1C), WBC, potassium, cholesterol, and urinalysis labs. In one embodiment, for all labs, the user is prompted for the date and time of the test. For each lab the healthcare application captures and tracks all clinically relevant data elements. For example, a particular statistic of interest relative to lung peak flow function is the end user's ratio of current peak flow to historical best peak flow. The healthcare system tracks this ratio and reports to end users and healthcare professionals when this ratio falls below critical levels. In some embodiments, the lab results are pushed from the medical laboratory to the server without the user being required to manually enter the results of the lab work.

My Labs section also allows the user to request a graphical representation (Images A41-A42) that tracks the trend of various organ functions like heart, lung, liver and kidney. All labs like all vitals are tracked and trended with goals set in the application. Target zones are created in lab graphs to provide an enhanced visual understanding of data to encourage health education, encouragement, and compliance. Also, patients can set their own user-defined health goals in the application. The personal goals may be shared with one or more other persons or entities in a social networking context. Sharing personal goals with others, in some cases, may encourage the patient to achieve the user-defined health goals.

The healthcare application provides the opportunity to attach a picture, audio, or video file to associate with each X-ray, EKG, or other lab.

Future embodiments of the healthcare application could also track health information such as dietary and nutritional intake and physical activity, e.g., sleep. The scope of data recorded by the healthcare application forms a comprehensive health record for an end user, making it possible to provide the full range of medical therapies without the need for ancillary encounters. In the case that end user's access healthcare facilities and/or professionals who are not regular sources of care or otherwise affiliated with the healthcare system, the healthcare application can export data to the EMR systems of these providers by converting the data into standard health informatics language, such as HL7.

### Server Synchronization and Analysis

The healthcare system automatically syncs data entered into the mobile devices of all end users to a secure data server. This server meets all the standards for safe and secure storage of personal health data, including those of the Health Insurance Portability and Accountability Act (HIPAA) and the Patient Safety and Quality Improvement Act (PSQIA). One of the functions of this synchronization is to back up the data stored of the mobile devices of end users in case of theft, corruption, disk failure, or other reason for data loss. However, the more transformative application is the creation of a database composed of the comprehensive health information of multiple end users. A detailed view of the back-end operations of the healthcare system is seen in FIG. 5.

One novel contribution of the healthcare system is the ability to populate the electronic medical records 15 of end users at multiple healthcare providers and facilities. By combining the outpatient data collected by the healthcare system with the inpatient data from providers, the healthcare system creates a complete and comprehensive health record, thereby improving the care a provider is able to deliver. The server 7 can populate electronic medical records 15 using standardized (e.g., HL7) or custom languages of healthcare providers. Transmission of health data to healthcare providers of end users complies with all data security and integrity standards, including authentication prior to and encryption throughout transmission.

The server 7 can be accessed locally and remotely for various purposes including data mining and clinical research. The set of entities capable to access the data stored on the server 7 include at least computational resources 19 of the healthcare system, PCPs (primary care physicians), insurance companies, pharmacies, pharmaceutical benefit companies, medical device manufacturers, drug companies, other healthcare providers of end users, and academic researchers.

In one embodiment, the computational resources 19 of the healthcare system 100 could exist in the same physical location as the server 7. In this case, these computational resources 19 communicate with the server 7 via secure local area network (LAN). Another embodiment of this disclosure could have the computational resources 19 residing in a remote location. Cloud computing with data analytics is also within the scope of some embodiments. The computational resources 19 run algorithms that support at least the primary tasks of (1) ensuring and improving compliance of care with established evidence-based guidelines, (2) identifying trends and anomalies, and (3) creating new evidence-based guidelines. Ensuring compliance with evidence-based guidelines includes checking for known adverse drug interactions and quality of care standards (e.g., providing beta-blockers to heart failure patients). Adherence to prescribed care by PCPs and other healthcare providers is also analyzed by the computational resources. Identifying trends and anomalies includes identifying abnormal disease patterns (e.g., influenza outbreaks), where abnormalities may be because of prevalence, geographic intensity, or characteristics of infected individuals. The creation of new evidence-based guidelines includes extending the current knowledge base by discovering yet unrealized benefits and consequences of medications and therapies. Findings of the computational resources are presented via report to healthcare system administrators and to other relevant parties. These relevant parties may include drug companies, the Food and Drug Administration (FDA), CDC (Centers of Disease Control), healthcare providers, and patients. The computational resources 19 also serve to adjust the multiple thresholds for data elements based on idiosyncrasies of end users. Thresholds are initially set to normalized physiological parameters of the typical individual matching the characteristics of the end user. Based on repeated observation, the computational resources can recognize whether observations that fall outside of the normalized range necessarily represent cause for medical alarm. For example, heart rates vary considerably within similar individuals based on genetic, exercise history, and other factors. Therefore, thresholds for bradycardia and tachycardia will need to be adjusted on an individual basis. Algorithms run by the computational resources 19 are naturally oriented towards quantitative measurements such as weight or blood pressure, but also parse qualitative data such as written or oral descriptions of symptoms.

Healthcare professionals 10 and academic researchers 54 can access the data collected from end users and stored in the server 7 remotely. Healthcare professionals 10 access the data and trends of the end users 1 who are their patients. Communication with the server 7 is achieved via web-portals and mobile devices. In one embodiment, data is only viewable upon successful authentication via UPIN and password, biometric, or other security method, and consent from the end user 1. The purpose in providing healthcare professionals 10 access to the data stored in the server 7 is to allow review of the progress of patients and the effects of therapies performed, and to take a course of action, if needed. For example, a PCP could increase the dosage of a preventive migraine medicine if the desired effects are not achieved. Furthermore, healthcare professionals 10 can recommend educational and persuasive interventions based on the health data and goals recorded by end users 1. This functionality of the healthcare system 100 could allow a hospital to implement remote post-discharge follow-up, which has been shown to reduce readmissions (HERNANDEZ A F, et al., “Relationship Between Early Physician Follow-up and 30-Day Readmission Among Medicare Beneficiaries Hospitalized for Heart Failure”, Journal of the American Medical Association, 2010; 303(17):1716-1722.). Academic researchers access the server 7 remotely, via secure wireless protocols such as secure shell (SSH). By constructing a comprehensive health record from multiple end users 1, the healthcare system 100 creates a valuable research asset. The healthcare application 1A provides researchers 54 a personalized way of distributing data use agreements to end users 1, and obtaining informed consent for the use of their data in health services and clinical research. The comprehensive nature of the data would allow testing of complex interactions between health metrics and healthcare provided.

Though the healthcare system 100 offers considerable functionality and value to the end user 1, the healthcare system 100 could also be deployed by a healthcare provider or payer such as an accountable care organization (ACO). The healthcare system 100 could aid considerably in tracking post-discharge symptoms and compliance with recommended care. The graphical representations, reminder prompts, and feedback have the ability to engage the end users 1 in the informal care process. The tracking of vital signs and the ability to broadcast tailored education and intervention messages could also create significant value from a payer's perspective by predicting and preventing costly conditions. These functionalities serve to improve the continuity of care delivered from the healthcare system which has been shown to increase patient satisfaction and reduce hospital admissions, increasing the quality and cost-effectiveness of healthcare. A company could also use the information (e.g., data trends, goals, and target zones) to evaluate and coordinate health goals and provide incentives, rewards and health care savings based on reaching those goals. The use of a mobile device 8 to gather health data and monitor goals for this use is also unique.

### Information Supplied to End User

In one embodiment, after the first entry of any data element, the healthcare application 1A automatically generates graphs which show the trend over time in that data element. Goals, targets, and target zones can be set by the physician, health care provider, or other known standards. The goals may also be set and informed by algorithms that evaluate other data sets and provide “best overall health” considerations.

Trend graphs, such as the one seen in FIG. 4, can be viewed by clicking on the Data Graph icon just to the left of the data entry field, as seen in FIG. 3. These graphs show not only the dynamics in the observations recorded in the healthcare system, but also multiple thresholds for data elements. These thresholds can serve to indicate target, warning, and dangerous levels or zones. These thresholds are initially set by population average standards, but are adjusted in response to personal characteristics of the user and clinical evidence from both physicians and the healthcare system. For example, for a user tracking their weight, thresholds for users will vary depending on height and body type. Graphical presentation of data can be viewed from varying time windows including one week, one, three, or six months, and one or two years (or longer). The healthcare system also informs the end user about the positive or negative trends in vital signs by color-coding to indicate the direction of change. When data observations are entered that are within target zones, healthy, break negative trends, or sustain positive trends, the end user can receive a pleasing tone from the mobile device. When observations are recorded which reflect unhealthy choices, are outside of target zones, sustain negative trends, or break positive trends, the end user might receive a displeasing tone.

An example of complex data integration might include when your BP is going toward a better level but your kidney function is deteriorating with the lower (better) range. Complex visual and tonal data might allow you to better understand this trend.

Thus, the healthcare system 100 is designed to evaluate multiple inputs and data sets to send reminders and action plans (e.g., medication changes, vaccination requests, blood pressure and weight goals, etc.).

Educational and intervention strategies communicated to the end user 1 through the mobile device 8 running the healthcare application 1A are generated by both the computational resources 19 and healthcare professionals 10. In addition, known clinical guidelines and “best practice” information is communicated to end users 1 and noted to provider. Given what interventions need to be supplied to the end user 1, the healthcare system 100 uses behavioral change and tailoring theories to engage the end user at the most opportune time. By dynamically recording responses to intervention from each end user 1, the healthcare system 100 uses machine learning algorithms to update the timing, schema, and phrasing in order to maximize responses.

Medication alerts based on time of day can be sent out and compliance modules requesting “yes” or “no” to the question of “did you take your medication?” allowing tracking of compliance and better understanding of vital sign and lab results. For example, “Your Blood Pressure is up because you didn't take your medication.”

Additional embodiments of the healthcare system 100 have a prescription module (i.e., prescription imaging software to scan or take picture of a prescription and ability to send images to pharmacy and authenticate the prescription). Updated prescription information appears in the My Meds section of the healthcare application 1A.

Still further embodiments have an alarm clock and an Awake/Sleep module to record sleep and/or an exercise module that records exercise time or gym use.

Still further embodiments have a timed message or vocal query to the end user 1 with questions like “how do you feel this morning”, “how did you sleep last night”, “do you have any new concerns?” with an ability by the application to record, understand (via language search tools) and respond with health recommendations.

Still further embodiments have a button for a text/print/e-mail or fax of a summary page that could be used in a patient registration process.

Future embodiments will have an immediate access button 26 for audiovisual communication with a health provider.

In some embodiments, insurance companies with appropriate permissions are able to view on server 7 user/healthcare interactions they are responsible for paying for. In one use case, an organization may have many employees that are policy holders of an insurance company. The employees can each be provided access to a healthcare application, such as healthcare application 1A. The employees track their health using the healthcare application 1A, as described herein, in conjunction with their healthcare providers. In one embodiment, when the employees are complying with the recommendations of the healthcare providers (e.g., generally living a healthy lifestyle), then the insurance premiums for the company may be lowered. However, when the employees are not complying with the recommendations of the healthcare providers (e.g., generally living an unhealthy lifestyle), then the insurance premiums for the company may be increased. Accordingly, embodiments of the invention provide for dynamic health care premiums based on whether one or more end users are complying with certain healthcare recommendations. In some embodiments, the healthcare application may ask the patient to input a response to a question, such as “Have you taken your medication today?” When the patient responds positively, i.e., in compliance with the provided medical advice, then this creates value for the patient. In some embodiments, the value may be a “point system.” The patient can earn points in a variety of ways, including answering queries from the healthcare application in compliance with medical advice. Once the patient earns a certain number of points, a benefit may be provided to the patient. For the example, the benefit may be lowered healthcare premiums. In other embodiments, the value comprises points, monetary value, dividends, gifts, or coupons.

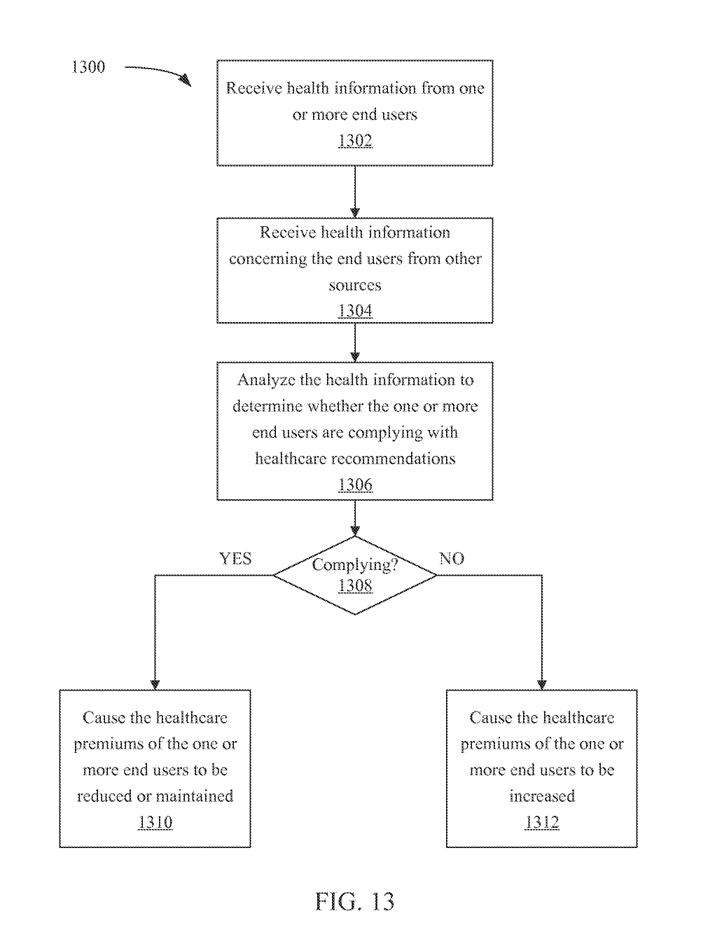

FIG. 13 is a flow diagram of method steps for providing health insurance, according to one embodiment. Persons skilled in the art will understand that even though the method 1300 is described in conjunction with the systems of FIGS. 1-12, any system configured to perform the method stages is within the scope of embodiments of the disclosure.

As shown, the method 1300 begins at stage 1302 where a server receives health information from one or more end users. As described herein, the health information can be received via a healthcare application executing on a mobile phone operated by the end users. At stage 1304, the server receives health information concerning the end users from other sources. Examples of other sources include a pharmacy, a medical laboratory, a radiology clinic, one or more healthcare professionals, one or more researchers, and/or one or more health measurement devices. In some embodiments, stage 1304 is optional and is omitted, as indicated by the dotted lines around stage 1304.

At stage 1306, the server and/or computational resources coupled to the server analyze the health information to determine whether the one or more end users are complying with healthcare recommendations. The healthcare recommendations may be provided by one or more of healthcare professionals, insurance companies, employers, and or any other entity.

At stage 1308, the server and/or computational resources determine whether the end users are complying with the healthcare recommendations. If the server and/or computational resources determine that the end users are complying with the healthcare recommendations, then the method 1300 proceeds to stage 1310. At stage 1310, the server and/or computational resources cause the healthcare premiums of the one or more end users to be reduced or maintained.

If, at stage 1308, the server and/or computational resources determine that the end users are not complying with the healthcare recommendations, then the method 1300 proceeds to stage 1312. At stage 1312, the server and/or computational resources cause the healthcare premiums of the one or more end users to be increased.

In this manner, embodiments of the disclosure provide for dynamic healthcare premiums based on whether one or more end users are complying with certain healthcare recommendations.

In another embodiment, the healthcare system 100 can be used to identify trends in health data. The server 7 and/or computational resources 19 may be configured to analyze the data received from multiple end users to identify possible trends in the data. For example, server 7 and/or computational resources 19 could identify potential health complication associated with certain medications, combinations of medications, medical outbreaks/conditions occurring within a geographic region, problems with a particular lot of medications or vaccines, medication complications with certain genotypic information, or any other information that can be ascertained from analyzing data associated with a plurality of individuals. Since the healthcare system 100 has access to all of the different data sets, as described above, and has access to these data sets for many individuals, the healthcare system 100 is able to extrapolate the data and/or identify trends in the data.

Additional embodiments of the healthcare system 100 and healthcare application 1A allow for end users 1 and healthcare providers 10 to have live remote encounters including written (typed) communication, video, audio, and pictures using built-in cameras, microphones, and other sensory inputs of the end user's mobile device 8. By utilizing mobile devices 8, which can be in near constant contact with end users 1, the healthcare system 100 has the ability to engage end users 1 in a timely and consistent fashion. By addressing the end user 1 through vital sign trend graphs with thresholds, short message service (SMS) messages, voice, picture, and video educational and instructive interventions from pre-planned and live resources, the healthcare system 100 significantly enhances the ability to communicate and manage medical therapies without the need for face to face encounters between end users and healthcare professionals.

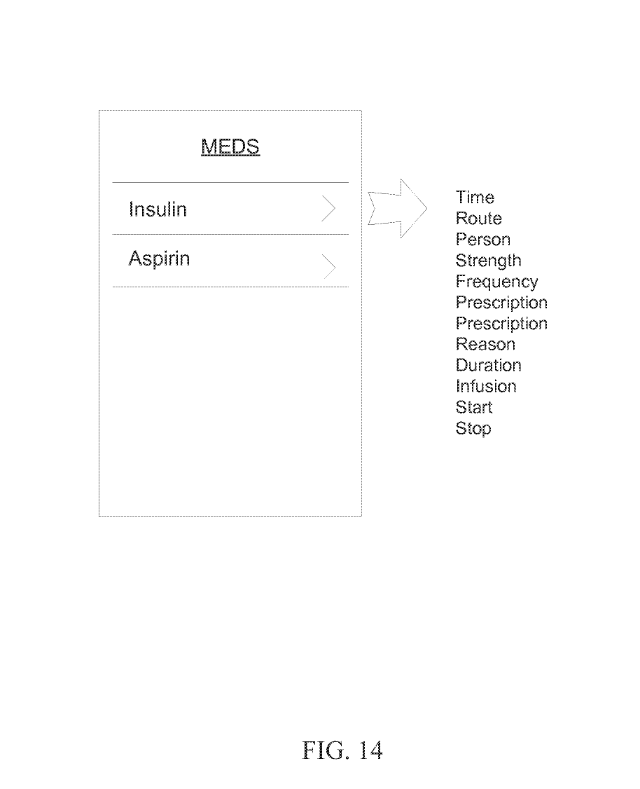

FIG. 14 is a conceptual diagram illustrating an expanded medication section of a healthcare application, according to one embodiment. In the example shown, the expanded medication section shows: time, route, person, strength, frequency, prescription, prescription reason, duration, infusion, start, and stop. Other data can also be shown.

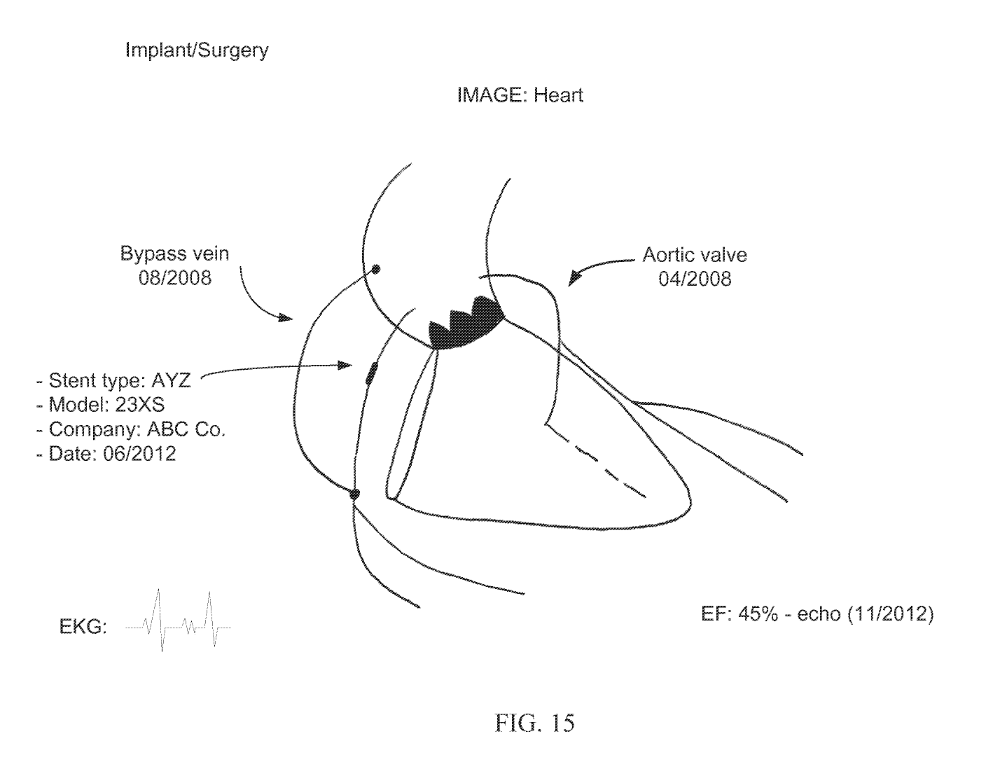

FIG. 15 is a representation that may be created using 3D modeling and 4D time sequencing to understand changes in medical history, according to one embodiment. In one embodiment, FIG. 15 illustrates a 2D representation of what would be created using 3D modeling and 4D time sequencing to understand changes in the history of a heart in terms of function, EKG, implants, and surgeries. Data incorporated from heart testing, surgery, implants, medications, etc. is collected to present a real-time representation and allow review of history on pages for intervention dates or with video like presentations scrolling through time.

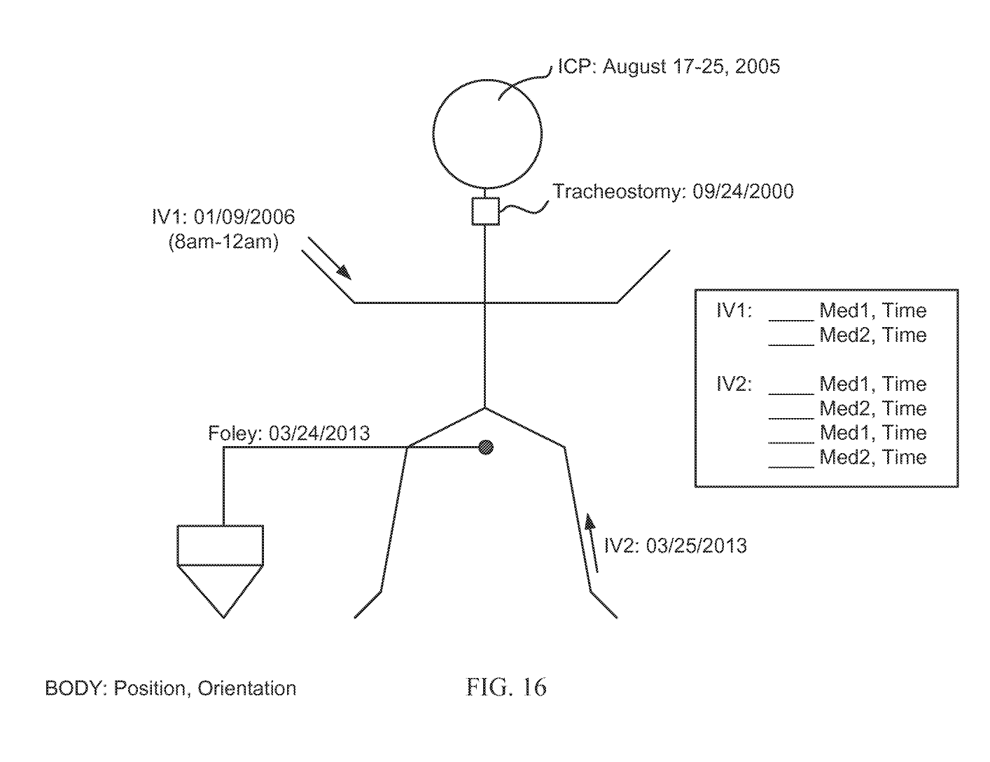

FIG. 16 is a representation of data that may be incorporated in anatomic modeling, according to one embodiment. In one embodiment, Figure illustrates what 3D and 4D anatomic modeling might incorporate and visualize from various data sets in accordance with embodiments of the disclosure. These 3D images could be populated and created by analyzing data from medical records (EHR). In some embodiments, using the 3D models allow better data entry by allowing nurses and other medical professionals to experience and duplicate their interventions onto 3D models. These models could then create data to populate the EHR, which may allow for faster and better data entry and allows for more timely entry by duplicating action on the patient with action on the 3D model. For example, a patient may have receives two IVs, IV1 and IV2. “Scanned meds” could be noted as scanned and placed as med entry for connection to IV2. IV2 could have a location, such as the leg. Foley, tracheostomy tubes, CVP lines, CSF drains, Foley catheters, etc. could all have 3D renderings and these connections would be part of a tool set created for placing in/on/into the patient. 3D models of organisms could also have orientations and body position notations. All connections would have things connected noted with a notation. For example, medications going into IV1 on Jan. 9, 2006 from 8 am to 12 am.

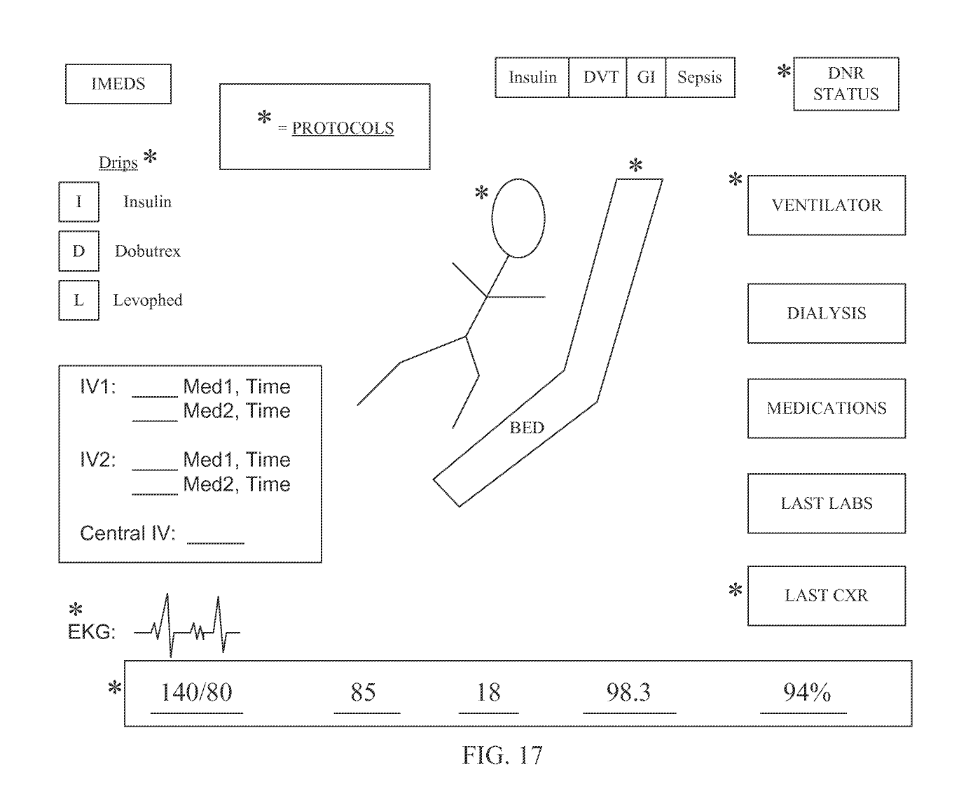

FIG. 17 is a conceptual diagram illustrating a virtual healthcare room, according to one embodiment. In one embodiment, the health information collected by the server is represented as one or more icons superimposed on a video of a patient either in real time or delayed time. This creates a system of health information layering on a video feed. This creates a “view” of a patient room. In some embodiments, the icons represent machines, devices, and equipment in the healthcare room and are rendered as a virtual machine. When a user selects an icon to open, additional information may be displayed on the device. In some embodiments, the devices and integrated healthcare products interacting with the patient have a virtual presence and can be placed in a “view” of the healthcare room. The “ view” of the healthcare room may be a computer screen shot (with the virtual patient) or a video feed with icons of machines and icons of devices, such as, for example, infusion pumps, ventilators, dialysis machines, intra-aortic balloon pumps, etc. This healthcare room “view” could incorporate immediate and delayed vital signs, XRAYs, and/or lab data superimposed on the video feed or screen shot. Also, the virtual healthcare room can provide a virtual presentation of a room with a virtual patient and the healthcare devices involved in delivering care.

In the example shown in FIG. 17, one screen has all the items and physical objects represented that are in the real patient room. In addition, XRAYs, labs, and medications are shown in the virtual healthcare room as well. These are represented as icons that can be opened, for example, with a touch on a touch screen. The Virtual Patient also exists in the virtual healthcare room and can be opened/selected for more details, for example, with a touch on the touch screen.

In some embodiments, certain items in the virtual healthcare room should appear opened in the default screen setting. These appear in FIG. 17 with the “*” notation. Examples include last vitals, a continuous EKG feed, continuous CVP or ICP pressures, DNR status, protocols, IV drips, ventilator settings, along with bed and virtual patient. Other examples are also within the scope of embodiments of the disclosure. In some examples, a touch screen function on these icons would allow opening up for additional information.

This virtual healthcare room and its icons could in the disclosed system sit on an audio/video feed of the patient room or exist alone as a screenshot on the healthcare application. Some embodiments create a time sequencing of events easier, and nursing staff can use the touch screen for their notations of actions taken on the patient. Conventionally, this usually is done later in the shift, creating a time problem, and requires remembering. In the disclosed system, virtual patient action can take place at the same time (or almost the same time) as the real patient interaction. This system creates a duplicate of actions in a virtual patient healthcare experience.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for providing insurance, comprising:
receiving health information from one or more users;
analyzing the health information to determine whether the one or more end users are complying with healthcare recommendations, and
adjusting insurance premiums based on whether the one or more end users are complying with the healthcare recommendations.

2. The method of claim 1, wherein a mobile device receives the health information and analyzes the health information, wherein analyzing the health information includes analyzing goals, trends, and/or trend lines of established goals for measures of successful completion of the goals and assigning value.

3. The method of claim 1, wherein the health information is received from the one or more users via a healthcare application executing on one or more mobile phones.

4. The method of claim 1, wherein the health information is received from one or more of a pharmacy, a medical laboratory, a radiology clinic, one or more healthcare professionals, one or more researchers, and one or more health measurement devices.

5. The method of claim 1, wherein each of the one or more users is a member of an organization, wherein the insurance premiums of the organization are increased when the one or more users are not complying with the healthcare recommendations, and wherein the insurance premiums of the organization and/or costs of the organization are reduced or maintained when the one or more users are complying with the healthcare recommendations.

6. The method of claim 5, wherein the organization provides incentives, rewards, and/or health care savings to the one or more end users that are complying with the healthcare recommendations, wherein the incentives, rewards, and/or health care savings comprise points, monetary value, dividends, gifts, or coupons.

7. The method of claim 1, wherein the health information includes a datestamp, a timestamp, and location information.

8. The method of claim 1, further comprising, in response to receiving the healthcare information, causing education and intervention messages as video, audio and/or text to be transmitted to the one or more users based on the healthcare information.

9. A system for collecting and analyzing health information of end users, comprising:
a server that communicates with a mobile device associated with an end user,
wherein the mobile device is executing a healthcare software application for collecting health information from the end user, and
wherein the server communicates with computational and analytical resources that analyze the health information collected from the end user.

10. The system of claim 9, wherein the server and/or the computational and analytical resources is configured to perform one or more of:
analyzing the health information to identify trends, issuing flags when certain conditions are detected,
informing healthcare professionals and/or the end user of identified trends,
analyzing the health information to check for known adverse drug interactions based on a combination of medications and/or genotypic information,
analyzing the health information to identifying abnormal disease patterns based on prevalence, geographic intensity, and/or characteristics of infected individuals,
creating individualized medicine recommendations with feedback loops incorporating medications, blood work, organ functions, vitals, genotypes, physiologic testing, and/or anatomic testing, and
executing machine learning and other algorithms in order to adjust thresholds, target zones, and goals for end users from normalized population parameters based on one or more factors associated with the end user.

11. The system of claim 9, where the health information participates in large data analysis generating new information, wherein the new information comprises example drug side effects and/or a percentage of patients affected.

12. The system of claim 9, wherein the health information is entered into the healthcare software application by a medical professional while administering care to the end user, wherein the healthcare software application is configured to allow manual data entry, and also automatic entry from home-based, office-based, laboratory-based, worn, and/or embedded health measurement devices via wired and wireless connections to the server.

13. The system of claim 9, wherein the healthcare software application records data which have standard measurements and scales, as well as data which has no standardization, is subjective, or is self-reported by the end user.

14. The system of claim 9, wherein the healthcare software application is configured to present to the end user a graphical visualizations of time-varying health information entered by the end user, trends and recent progress/regress for health information entered by the end user, goals and target zones for health information entered by the end user, and/or one or more upper and lower thresholds for health information entered by the end user.

15. The system of claim 9, wherein the server is configured to populate electronic medical records based on the health information collected via the healthcare software application, wherein the electronic medical records include a subset of the health information collected via the healthcare software application, and wherein the electronic medical records comprise a single sheet of paper when printed.

16. The system of claim 9, wherein the server is configured to send feedback, responses, education, interventions, and/or recommendations generated by the server and/or computational and analytical resources to the end users.

17. The system of claim 9, wherein the healthcare software application is used to report adverse events, new signs, symptoms, and/or reactions, including adverse events related to medications or implants in use by the end user.

18. The system of claim 9, wherein the server is configured to generate a model of a virtual patient based on the health information collected, wherein the model is a 2D, 3D, and/or 4D model, and wherein the model is an anatomic and physiological model.

19. The system of claim 18, wherein the model comprises a 3D model of a patient or organ that mimics a patient or organ as whole or in part, wherein the patient is a person, an animal, or other organism.

20. The system of claim 18, wherein the model includes data representing one or more of:
medications, with information for time, route, person, frequency, dose, prescription, duration, and rate of infusion,
implants and surgical procedures, and
connections, drains, lines, and/or tubes, including information about placement or removal;
wherein the model is configured to be altered by a medical professional via tool sets that allow certain actions to be placed easily on or in the model by the medical professional

21. The system of claim 18, wherein an EHR (electronic health record) provides the data incorporated into the model, and/or wherein the model provides data to the EHR such that cells in the EHR are updated based on actions taken on the model.

22. The system of claim 18, wherein the model is manipulated with new data using a touch screen to make connections in the model and/or alter the model.

23. The system of claim 9, wherein the health information comprises one or more of medications and infusion rates, ventilator settings, amount of oxygen in use, DNR (do not resuscitate) status, protocols in use, tubes, lines, and catheter in use.

24. The system of claim 23, wherein the health information is represented as one or more icons superimposed on a video of a patient either in real time or delayed time, wherein the icons represent machines, devices, and/or equipment in a healthcare room such that selecting an icon provides for additional information to be displayed on the mobile device, wherein the machines, devices, and/or equipment have a virtual presence and can be placed in a view of the healthcare room.

25. The system of claim 24, wherein the view of the healthcare room is a computer screen shot or a video feed, wherein the machines, devices, and/or equipment comprise one or more of infusion pumps, ventilators, dialysis machines, and intra-aortic balloon pumps, and wherein the view of the healthcare room incorporates one or more of immediate and/or delayed vital signs, XRAYs, and lab data superimposed on the computer screen shot or video feed.

26. The system of claim 24, wherein the view of the healthcare room is a virtual presentation of a room with a virtual patient corresponding to a patient and one or more healthcare devices involved in delivering care to the patient.

27. The system of claim 9, wherein the health information is received by the server from a plurality of sources, wherein health information from different sources is coded differently, wherein health information from a first source is coded with a first color and health information from a second source is coded with a second color.

28. The system of claim 9, wherein the healthcare application allows multiple healthcare providers to send messages to one another, with a copy of the messages being sent to the end user.
